(19) United States
(12) Patent Application Publication
(10) Pub. No.: US 2025/0256265 A1
(43) Pub. Date: Aug. 14, 2025

(54) EXTRACTION MEDIUMS AND METHODS FOR SELECTIVE REMOVAL, CONCENTRATION, AND RECOVERY OF PFAS WITH FLUOROUS BIPHASIC AND MULTIPHASIC SYSTEMS AND RELATED METHODS

(71) Applicant: Cristina Piekarz, Vallejo, CA (US)

(72) Inventor: Cristina Piekarz, Vallejo, CA (US)

(21) Appl. No.: 18/959,432

(22) Filed: Nov. 25, 2024

Related U.S. Application Data
(60) Provisional application No. 63/602,561, filed on Nov. 24, 2023.
(60) Provisional application No. 63/677,346, filed on Jul. 30, 2024.
(60) Provisional application No. 63/694,851, filed on Sep. 14, 2024.

(51) Int. Cl. B01J 20/34; B01D 11/04; C02F 1/28; C02F 101/36

(52) U.S. Cl. CPC B01J 20/3475; B01D 11/0492; B01J 20/3491; C02F 1/28; C02F 2101/36; C02F 2303/16

(57) ABSTRACT

Extraction media for removal, concentration, and recovery of PFAS from contaminated materials in fluorous biphasic and/or multiphasic systems and related methods. The systems may include a fluorous functionalized solid support and a fluorous fractionation reactor permitting PFAS separation for targeted recovery. Extraction mediums comprise a polyelectrolyte with carbon dioxide/supercritical carbon dioxide (CO₂/scCO₂) with additional possible reagent modifiers that permit miscibility switches and compatibility with NSF/ANSI certifications. The extraction medium may include modifiers to enhance targeted recovery, such as F-solvents and/or organic carrier solvents. The disclosed systems and methods permit advantages such as 1) reduced sensitivity to PFAS-impacted phase co-contaminants such as competing anionic species and/or organic contaminants, 2) simple contact reactor retrofits, 3) enhanced removal of ultra- and/or short chain PFAS, 4) enhanced uniformity of matrix chemistry for downstream waste/wastewater management processes, and 5) the ability to recover valuable PFAS from waste/wastewater for processes that are dependent on their chemistry.

### CROSS REFERENCE TO RELATED APPLICATIONS

The present application claims priority to: U.S. Provisional Patent Application No. 63/602,561, filed on Nov. 24, 2023; to U.S. Provisional Patent Application No. 63/677,346 filed on Jul. 30, 2024; and to U.S. Provisional Patent Application No. 63/694,851 filed on Sep. 14, 2024, each of which is incorporated herein by this reference in its entirety.

### FIELD OF THE INVENTION

The present invention relates to extraction media and methods for selective removal, concentration and recovery of Per- and Polyfluoroalkyl Substances (PFAS) in the presence of inorganics and/or other co-contaminants with fluorous biphasic and multiphasic systems, and more particularly to systems and methods for introducing a PFAS-impacted phase to a contact reactor having a solid phase comprising a fluorous functionally modified solid support, adsorbing PFAS from the PFAS-impacted phase to a solid phase, separating the treated phase from said PFAS-concentrated solid phase and recovering PFAS from said PFAS-concentrated solid phase in the contact reactor.

### BACKGROUND OF THE INVENTION

The discovery of fluorous chemistry and its benefits, including that the “fluorous phase” is immiscible in both aqueous and organic liquid phases. Fluorous chemistry offers unique advantages in separation and synthesis through the use of fluorine-rich phases. Its primary benefit lies in simplifying purification, as fluorous-tagged compounds can be easily separated using fluorous-solid phase extraction or biphasic systems. Applications include catalysis, where fluorous catalysts can be efficiently recycled, and drug discovery, where fluorous tags enhance compound identification. Fluorous chemistry is widely employed in materials science, enabling the creation of advanced fluorinated polymers and coatings with exceptional chemical resistance and thermal stability. Fluorous chemistry has enabled many developments for pharmaceuticals, medical devices, semiconductors, aerospace applications, energy applications, personal protective equipment, national security, and many other critical services.

The development of the unique and useful properties of PFAS (per- and polyfluoroalkyl substances) led to their widespread application, release, and disposal. Many of the properties that enabled important advances to critical services, also resulted in their persistence in the environment and public health impacts.

Regulations promulgated to restrict the concentrations and usage of PFAS impact many industries and compliance with these regulations poses a challenge. The PFAS regulatory landscape has been evolving with an emphasis on drinking water standards, waste management/disposal, and the phasing out of various products, applications, and compounds. The Environmental Protection Agency's maximum contaminant and ppt levels for various compounds and the classification of PFAS under Comprehensive Environmental Response, Compensation, and Liability Act (CERCLA) present compliance challenges for companies and other entities that could utilize fluorous chemistry applications.

While some PFAS applications such as food packaging, personal care products, and other consumer products may find suitable fluorous chemistry substittions, other sectors may be hindered in the development of alternatives. In 2024, the U.S. Chamber of Commerce released a report that assessed the economic impact that a fluorous chemistry ban would have on various sectors of the economy and found that businesses that use PFAS “support nearly $1 trillion in U.S. GDP”, “account for over 6 million jobs”, and that it “would take decades to transition to alternatives”.

Regardless of how regulatory enforcement unfolds, there is a need for better PFAS-impacted waste and wastewater management/disposal processes. In order to protect public health and reduce environmental persistence, improvement is needed in the removal efficacy, cost, and reliability of PFAS treatment processes. There is also a need to selectively recover various fluorous compounds for potential reuse in industry sectors that are dependent on such compounds.

While the use of granular activated carbon (GAC) and anion exchange resin (AIX) are widespread due to their low cost and availability, both treatment processes have drawbacks with respect to 1) treatment efficacy associated with the removal of short and ultra-short chain PFAS compounds, 2) frequent media exhaustion resulting in inefficiencies, and 3) the presence of co-contaminants such as organics, sulfate, bicarbonate, chloride, and other constituents that reduce the efficiency of PFAS removal. In 2021, a Water Research journal article was published that compared nine commercial AIX resins for their efficacy in removing PFAS from drinking water spiked with 600 ppt of 40 PFAS compounds. The resin contact times consisted of 15 min, 2 hour, and 24 hours and the water matrix anionic species concentration of sulfate and chloride were 23 ppm and 28 ppm, respectively. Testing for perfluorooctanesulfonic acid (PFOS), perfluorooctanoic acid (PFOA), perfluorohexane sulfonate (PFHxS), perfluorononanoic acid (PFNA), perfluorobutane sulfonic acid (PFBS), and GenX™ chemicals, it was observed that 1) after 15 minutes of resin contact time, the removal of PFOA, PFHxS, and GenX™ chemicals was less than ˜50% for all of the commercial resins tested (i.e., effluent >300 ppt), 2) at least 2 hours of contact time was required for >90% removal of PFOS, PFOA, PFHxS, and PFNA (i.e., effluent <60 ppt), 3) four of the nine commercial resins tested did not achieve >50% removal of perfluoroalkyl ether carboxylic acids (PFECAs, found in GenX chemicals) (i.e., effluent >300 ppt), and 4) long-chain PFAS removal from the resin during the regeneration process was not observed when the organic solvent content was <20%. Alternative PFAS removal processes are needed to complement existing treatment processes such as GAC/AIX, and/or retrofit existing systems to improve removal efficacy, process reliability, and media regenerability.

In U.S. Pat. No. 10,287,185 B2 (the “185 Patent”), a regenerable anion exchange system for removing and concentrating PFAS is disclosed that includes an anion exchange vessel configured to remove PFAS from water and “an optimized regeneration solution” to remove PFAS from a “strong base, anion exchange resin”. It's disclosed that the regeneration solution may include a mixture of a salt or a base, a solvent that may include an alcohol, and water. The '185 patent also discloses a separation and recovery system to recover the regeneration solution for reuse and separate the removed PFAS using methods such as distillation and/or other thermal means. While the '185 patent addresses concentrated regeneration processes, there are practical problems with its disclosed methods such as 1) the “optimized regeneration solution” includes “50-90% methanol by volume”, which presents challenges with relevant fire protection codes, 2) the use of methanol limits applications that require ANSI/NSF certification for safe drinking water, 3) the use of a PFAS/solvent separation system such as distillation entails the potential vaporization of volatile PFAS compounds, which may present a problem achieving a complete PFAS removal balance, and 4) the spent regeneration solution after processing through distillation has a high concentration of salt (i.e., 1-5 wt % or 10,000-50,000 ppm), which would impact downstream processes such as destructive/mineralization treatment, discharge, and/or further concentration.

Furthermore, at the International Water Conference in 2022, a paper was presented by 3M that discussed the initiation of several pilot studies to assess water treatment technologies for the removal of PFAS to “support their commitment to environmental stewardship”. The pilot testing results were presented and discussed for the use of a regenerable resin process (i.e., U.S. Pat. No. 10,287,185) for treating PFAS-impacted water matrices for the removal of ultra-short chain PFAS in the presence of anions such as sulfate, chloride, alkalinity, etc. For the purposes of simplifying discussion, a stormwater matrix comprising a total PFAS concentration of 69 ppb in the presence of approximately 1,200 ppm, total alkalinity as CaCO₃, 520 ppm sulfate, 285 ppm chloride, and other constituents was fed to two different strong, basic anion exchange resins in series, with an empty bed contact time (EBCT) of 40 minutes. The PFAS breakthrough occurred at 120 bed volumes (BVs) for the pilot testing, but discussion was limited related to the regeneration process.

Over the past few decades, 3M has filed multiple patent application filings related to processes for PFAS removal and/or recovery from wastewater such as U.S. Pat. No. 6,613,941 B1 (1999), EP 2,162,388 B1 (2008), UK 10117158 (2010), WO 2022/026865 A1 (2022), and WO 2023/144756 (2023). However, it is disclosed within WO 2023/144756 (2023), that even with the recent effort associated with the removal of fluoroorganic acids from aqueous media with alkylammonium compounds and anion exchange resin, “the complete and simultaneous removal of fluoroorganic compounds and polymer particles from water streams remains a desire”.

U.S. Pat. No. 6,613,941 B1 (3M, 1999) discloses a method for recovering fluorinated alkanoic acids from waste waters that involves first removing fine solids by precipitation, and then bringing the wastewater into contact with an anion-exchange resin and eluting the adsorbed emulsifier acids.

EP 2,162,388 B1 (3M, 2008) discloses a process for reducing fluorinated compounds in an aqueous phase that comprises adding one or more polycationic polymers to cause partial precipitation of the fluorinated compounds and adding one or more polyanionic polymers.

UK 10117158 (3M, 2010) discloses a process for removing fluoroorganic anions from an aqueous phase that comprises contacting the aqueous phase with a water soluble organoammonium (i.e., amine), wherein a fluoroorganic anion with the organoammonium forms a hydrophobic ion pair that is then separated from the aqueous phase. A base is added to the organic phase to recover the fluoroorganic anions and/or regenerate the amine.

WO 2022/026865 A1 (3M, 2021) discloses a process for removing fluoroorganic acidic compounds from a solution with at least one protic solvent, comprises an extraction composition with at least one trialkylamine and organic solvent, and reacting the fluoroorganic compounds with the trialkylamine to form a hydrophobic ionic compound and separating the compounds based on phases.

WO 2023/144756 (3M, 2023) discloses a process for cleaning up wastewater with fluoropolymer particles and fluoroorganic compounds with coagulation using an alkylamine, anion exchange resin, flocculant, and separation with a semi-permeable membrane.

Froth flotation, or as many in the art would refer to for PFAS as “Foam Fractionation”, is a stripping process that uses vapor/gas (i.e., air) to take advantage of the tendency for PFAS to partition to air/water interfaces so that the compounds can be removed from PFAS-impacted matrices. The removal efficacy for long-chain compounds is generally very high even in the presence of inorganics and the process is relatively inexpensive to operate, but foam fractionation processes are challenged with 1) the removal of ultra-short and short chain PFAS, 2) the propensity for certain PFAS to volatilize, 3) process optimization to balance PFAS removal rates and the volume of foam residuals generated, and 4) the concentration of salt/inorganics in the PFAS-concentrated foam, which can severely impact downstream processing.

US 2021/00300789 AI (OPEC, 2021) discloses a method and apparatus are disclosed for separating PFAS from water that involves introducing PFAS and a flow of gas into a chamber, which produces a froth layer which rises and can be removed from the upper portion of the chamber. In some embodiments, a bubble generation device is considered.

In 2024, a paper in Emerging Contaminants was published (Calore et al, 2024) providing a review and comparative assessment of peer-reviewed research between 2011 and 2023 related to sorption materials for the removal of PFAS. Data was summarized from publications for sorption efficiency, the type and concentrations of PFAS, adsorption equilibrium time requirements, adsorption capacity, sorption material recyclability, and other relevant study results for about 80 different sorption materials such as modified activated carbon (AC, proteins, polysaccharides, polyanilines, polyacrylonitriles, covalent organic frameworks (COFs), metal-organic frameworks (, MOFs, cyclodextrins, hydrogels, magnetic nanoparticles (NPs), clay-based, and zeolites. The comparative assessment performance metrics comprised the “1) the capability to remove PFAS (including short-chain and novel PFAS), 2) the adsorption performance under environmentally relevant conditions, 3) regenerability and reusability of the adsorbing materials, 4) material functionalities relevant to selectivity towards PFAS and/or towards short-chain PFAS over the long-chains”. It was summarized from the review that “COFs, nano(ligno)cellulosic-based materials, and layered double hydroxides were observed to be the most promising”, but the study noted the “continued lack of data on the applicability in real environments” and that research was still in its “infancy”. In addition, many of the sorption materials assessed did not use NSF/ANSI certified regeneration chemicals for drinking water applications.

Over the past decade, there have been many disclosures related to PFAS removal for functionalized media: WO 2020/160626 A1 (Queensland, 2020), WO 2022/159661 A1 (Fluorogel, 2022), US 2024/0002262 A1 (LDH, 2024), and US 2024/0010524 (Weaver, 2024).

WO 2020/160626 A1 discloses a method for capturing a fluorinated carbon that comprises contacting the fluorinated carbon compound with a block copolymer having a backbone comprising a hydrophilic block and a fluoropolyether block.

WO 2022/159661 A1 discloses a method of removing PFAS from water using fluoroolefin-vinyl ether copolymer containing ionic polymer networks.

US 2024/0002262 A1 discloses an alkyl-modified layered double hydroxide (LDH) and a polyfluoroalkyl-modified LDH.

US 2024/0010524 discloses a formula that comprises a silica support with alkyl or fluorous functionality for the removal of PFAS.

Although these disclosures advance teachings, there are a few practical issues with their use such as 1) the use of an organic solvent for regeneration of these media, such as alcohols, is not compatible with NSF/ANSI 60/61 certification, 2) the fluorous functionality and media should be thermally stable, (i.e., polymers are subject to thermal degradation and it's been found that leaching has been observed at >50 deg C.), 3) the solid support comprising the fluorous functionally should be not be subject to leaching constituents such as metals and/or other species, and 4) the particle size of the support should be practical and/or compatible for typical packed flow operations (i.e. particle sizes such as those discussed in US 2024/0010524 suggest a very high flow resistance under normal operation with excessive pressure drops).

The use of the fluorous phase for synthetic chemistry applications such as organic phase separations have been disclosed, e.g., in U.S. Pat. No. 5,859,247 (Curran et al, 1999), which teaches several methods are disclosed for synthesis and separation associated with organic/fluorous phases. Fluorous/fluorous separations have been limited, and fluorous/aqueous separations have been even further limited and improvement is needed. The Journal of Fluorine Chemistry published an article (Bailey et al, 2010) using fluorous-fluorous interactions as a means to isolate PFOS for mass spectrometric quantification using a fluorous liquid-liquid extraction in a triphasic solvent system of “hybrid:fluorous:organic solvent”. The use of trifluoroethanol: perfluorohexane/dichloromethane saturated with water was found to extract >90% of PFOS into the fluorous phase. Mochizuki et al published an article associated with using PFOA to extract alkali metal ions from aqueous solutions with crown ethers and supercritical carbon dioxide (Mochizuki et al, 1999).

U.S. Pat. No. 4,124,528 (Modell, 1978) discloses a process for regenerating adsorbents with supercritical fluids, such as supercritical carbon dioxide, to remove an adsorbate from an adsorbent material, such as activated carbon. The supercritical fluid is then further “subjected to a physical treatment which renders the supercritical fluid a nonsolvent for the adsorbate and makes it possible to remove the adsorbate from the supercritical fluid”. The supercritical fluid is then subjected to another physical treatment to restore it to a state where it can be used as a solvent. In the disclosure, the “physical treatment” that converts the supercritical to a nonsolvent involves decreasing the pressure and/or temperature.

WO 2024/010617 A1 (Evoqua, 2024) discloses a method using supercritical carbon dioxide to extract PFAS from adsorption media, adjusting the temperature and/or pressure, and/or supplementing the extraction with a solvent such as “water, alcohol, methanol, ethanol, acetonitrile, carbon disulfide, and ammonium hydroxide . . . ammonia or an alkylamine”. Also, an article published in Chemosphere (Chen et al, 2012) discloses the use of supercritical carbon dioxide, methanol, and an acidic amendment to extract PFAS from solid matrices. Although the acid-methanol modified extraction efficacies were high, the use of such solvents listed (i.e., alcohols, etc) is not compatible with NSF/ANSI applications.

There is therefore a need for more treatment and/or waste management processes to selectively remove, concentrate, and recover PFAS. Of priority are methods for 1) selective removal of PFAS from contaminated solid matrices (e.g., such as spent adsorbent media) using extraction solvents compatible with practical applications (e.g., certified for potable water applications), 2) selective removal of PFAS from complex matrices such as aqueous, vapor, and/or organic phases comprising constituents such as ultra-short and/or short chain PFAS, high concentrations of inorganic constituents, and/or other elements that comprise realistic waste/wastewater applications, 3) improving the concentration of PFAS to reduce the volume of wastewater residuals, improve process economics, and reduce the liabilities associated with the handling of the materials, 4) improving matrix chemistry for downstream destructive treatment processes, and 5) recovering PFAS from contaminated waste/wastewater so they can be re-used in processes that are dependent on their chemistry, inherently providing a financial incentive for their removal, reducing environmental discharge/disposal, and reducing manufacturing production demands.

Embodiments of the present invention provide systems and methods that address these needs.

### SUMMARY OF THE INVENTION

Embodiments of the present invention provide extraction media and methods for selective removal, concentration, and recovery of PFAS in the presence of inorganics and/or other co-contaminants in fluorous biphasic and multiphasic systems. Embodiments of the systems and extraction mediums comprise a polyelectrolyte and carbon dioxide/supercritical carbon dioxide (CO2/scCO2) with additional possible reagent modifiers that permit miscibility switches. Embodiments are disclosed for a fluorous functionalized solid support and fluorous fractionation reactor permitting PFAS separation for targeted recovery. Embodiments are disclosed for extraction medium modifiers to enhance targeted recovery such as F-solvents and/or organic carrier solvents. Several embodiments are disclosed comprising pretreatment methods and reactor systems for adsorption, foam fractionation, liquid/liquid extraction, solid/liquid extraction, and other processes. This disclosure permits advantages such as:
1. Reduced sensitivity to PFAS-impacted phase co-contaminants such as competing anionic species and/or organic contaminants;
2. Simple contact reactor retrofits;
3. Enhanced removal of ultra- and/or short chain PFAS;
4. Enhanced uniformity of matrix chemistry for downstream waste/wastewater management processes;
5. The ability to recover value from waste and wastewater by recovering PFAS for reuse in processes that are dependent on their chemistry; and
6. Reduced constraints for drinking water purveyors with extraction medium compatibility with NSF/ANSI 60/61.

Embodiments of the invention are described in more detail herein for PFAS removal, concentration, and recovery from PFAS-impacted liquid, vapor/gas, and/or solid phases in the presence of inorganics and/or other co-contaminants.

The methods and systems disclosed herein comprise the following common elements: an extraction medium, also referred to as “regeneration solution”, and a fluorous phase. The PFAS-impacted phase is contacted with a fluorous phase in a contact reactor wherein the PFAS species at least partially transfers to the fluorous phase. The fluorous phase may comprise a fluorous-functionalized solid support, also referred to as “F-media”. In other embodiments, the fluorous phase may comprise a fluorous solvent, also referred to as “F-solvent”. The selected option may be dependent on the process chemistry and concentration and recovery goals. In some embodiments in which a fluorous-functionalized solid support is used, a regeneration solution may be used to transfer PFAS from the solid support to the regeneration solution. In some embodiments, the PFAS compounds may be selectively recovered in the regeneration solution after contact in the contact reactor, also referred to herein as a “fluorous fractionation reactor”.

The fluorous-functionalized solid support (F-media) may include a fluorinated solid support such as silica, hydrous metal oxides such as aluminum oxides (alumina, activated alumina), zirconium oxides, or iron oxides, polymer beads, resin, high silica zeolites, layered double hydroxides, zero valent iron, silicalite, activated carbon, ceramics, silica beads, pellets, chips, fibers, shells, and/or nanoparticles. In some embodiments, the solid support comprises a metal oxide. In some embodiments, the solid support comprises aluminum oxide. In other embodiments, the solid support comprises a zero valent iron.

As discussed herein, the disclosed embodiments and implementations may include pretreatment applications such as adsorption, foam fractionation (e.g., froth flotation), liquid/liquid extraction, solid/liquid extraction, and other processes. For each of these pretreatment applications, the extraction medium (e.g., regeneration solution) may be coupled with the pretreatment process to selectively remove PFAS from the PFAS-impacted phase to form a PFAS-concentrated phase. The PFAS-concentrated phase may then be conveyed to a fluorous system for concentration and recovery and/or destruction.

The PFAS-impacted phase can be any source containing PFAS compounds. In various embodiments, PFAS impacted phases comprise contaminated adsorption media, drinking water, industrial wastewater, landfill leachates, foam fractionates, contaminated ion-exchange resins, contaminated ion-exchange resin regeneration solutions, contaminated activated carbon regeneration solutions, contaminated concentrated brine, membrane concentrates, contaminated gas/vapor, contaminated novel sorbent regeneration solutions, ground water, drinking water residuals, municipal wastewater, AFFF, contaminated soil wash water, or aqueous based solid slurries contaminated with PFAS.

In some embodiments, PFAS may be defined by current Organization for Economic Co-operation and Development (OECD) definitions. In some embodiments, PFAS may be defined by regulatory standards. For purposes of broad discussion, for a compound to be considered a PFAS, it must comprise at least one carbon-fluorine bond (i.e., be an organofluorine compound), but it is important to note that not all organofluorine compounds may be considered PFAS. The definition of PFAS may evolve over time and this disclosure is not intended to limit applications. In some embodiments, other organic compounds may also be a part of the PFAS-impacted phase (1). PFAS compounds in the impacted-phase may comprise the following list: PFOA, PFOS, PFNA, PFHxS, PFBS, HFPO-DA, TFA, PFBA, PFPeA, PFHxA, PFHpA, PFDA, PFUnA, PFDoA, PFTrDA, PFTeDA, PFPeS, PFHpS, PFNS, PFDS, PFDOS, 4: 2FTS, 6: 2FTS, 8: 2FTS, PFOSA, NMeFOSA, NEtFOSA, NMeFOSAA, NEtFOSAA, NEtFOSE, ADONA, PFMPA, PFMBA, NFDHA, 9CI-PF3ONS, 11CI-PF3OUdS, PFEESA, 3: 3FTCA, 5: 3FTCA, 7: 3FTCA, 13C4-PFBA, 13C5-PFPeA, 13C5-PFHxA, 13C4-PFHpA, 13C8-PFOA, 13C9-PFNA, 13C6-PFDA, 13C7-PFUnA, 13C2-PFDoA, 13C2-PFTeDA, 13CC3-PFBS, 13C3-PFHxS, 13C8-PFOS, D3-NMeFOSAA, PFO2HxA, PFO30A, PFO4DA, PFO5DA, PEPA, PFECA_B, PFECA_G, D5-NEtFOSAA, 13C2-4: 2FTS, 13C2-6: 2FTS, 13C2-8: 2FTS, 13C3-HFPO-DA, D7-NMeFOSE, D9-NEIFOSE, D5-NEtFOSA, D3-NMeFOSA, 13C3-PFBA, 13C4-PFOA, 13C2-PFDA, 13C4-PFOS, 13C5-PFNA, 13C2-PFHxA, 1802-PFHxS, PEPA, PFECA-G, PFMOAA, PFO2HxA, PFO3OA, PFO4DA, PMPA, Hydro-EVE Acid, PFECA B, R-EVE, PFO5DA, NVHOS, PES, PFDoA, PFHpA, PFTeA, PFTriA, PFUnA, PFPeS, 10:2 FTS, NEtFOSAA, NEIPFOSA, NEIPFOSAE, NMeFOSAA, NMePFOSA, NMePFOSA, NMePFOSAE, PFDOS, PFOSA, PFODA, or a combination thereof. There are thousands of PFAS compounds, and this list does not intend to limit the compound(s) that comprise the organic compound feed. In some embodiments, PFAS are considered solutes. In some embodiments, PFAS may comprise PFOA, PFOS, PFNA, PFHxS, PFBS, hexafluoropropylene oxide dimer acid (HFPO-DA), and combinations thereof. In some embodiments, the total concentration of PFAS (e.g., as per EPA Method 1633) in the waste feed comprises >1,000 ppm, <1,000 ppm, <100 ppm, <50 ppm, <10 ppm, <1 ppm, <100 ppb, <10 ppb, <1 ppb, <700 ppt, <500 ppt, <250 ppt, or <100 ppt.

The selective transfer of PFAS from one phase into another phase is driven by the difference in chemical potential between phases. The means to quantify the selectivity, or phase preference, can be given by the partition coefficient as shown in Equation (1) as the ratio of solute concentrations between phase 1 over phase 2.

$$Kc = \frac{[ {C}_{PFAS , 1} ]}{[ {C}_{PFAS , 2} ]} \qquad Equation ( 1 )$$

The selectivity can be tuned by manipulating properties of the phases such as temperature, pressure, fluorine content, steric effects, resonance effects, electrostatic charge, functional groups, isomers, wettability, and/or other parameters. In a preferred embodiment herein, the regeneration solution comprises chemical combinations that are compatible with NSF/ANSI certifications as will be discussed. The present disclosure provides novel chemistry and parameters for improving partitioning behavior of PFAS compounds between phases, particularly for aqueous systems using chemicals that are compatible with potable water applications to meet NSF/ANSI certifications.

For purposes of discussion, the Hildebrand solubility parameter (δ) can be used in non-polar applications to determine the relative miscibility of phases and/or the preference for a solute to be in a particular phase. Phases/solutes with similar δ values tend to be miscible. The Hildebrand solubility parameter is represented by Equation (2), which is not discussed in extensive detail herein, but provides a numerical estimate of the cohesive energy density: i.e., the ability to overcome the energy required for solvation.

$$δ = \sqrt{\frac{Δ {H}_{v} - RT}{{V}_{m}}} or {δ}^{′} = \sqrt{\frac{Δ {{E}^{′}}_{v}}{{V}_{b}}} = \sqrt{\frac{\sum {( Δ {{E}^{′}}_{v} )}_{i}}{\sum ( {V}_{i} )}} \qquad Equation ( 2 )$$

In their neutral form, PFAS typically have low δ values (e.g., 5-20 MPa½), while the δ of organics have a higher range (e.g., 20-30 MPa½). Water has a very high δ value (e.g., approximately 45-50 MPa½). PFAS in their anionic form have a higher miscibility water.

The neutral form of PFAS are non-polar and prefer fluorophilic phases. For many media regeneration processes associated with PFAS removal, conventional regeneration solvent chemicals typically comprise organic solvents such as methanol or other chemicals for extracting PFAS. Not only are organic solvents such as methanol not NSF/ANSI certifiable and create barriers to entry (e.g., fire protection codes, etc.), the δ value is approximately 30 MPa½ for methanol, which is orders of magnitude different than that for fluorinated compounds, which could be optimized further.

In some embodiments, the regeneration solution (11) comprises one or more polyelectrolytes, carbon dioxide, and water. In some embodiments, carbon dioxide may be at supercritical conditions. The polyelectrolyte serves multiple functions in the PFAS collection and media regeneration processes. It acts as a phase transfer catalyst, facilitating the transfer of PFAS compounds from the fluorinated media or other matrices into the regeneration solution. By providing an electrostatic charge, the polyelectrolyte interacts with PFAS molecules, which often exist as anionic species, improving the efficiency of PFAS desorption and partitioning into the solvent phase. The functionality of the polyelectrolyte can be activated or deactivated depending on the solution chemistry, such as pH, ionic strength, or the presence of other reagents, allowing it to adapt to varying operational conditions. Additionally, the polyelectrolyte enhances the properties of the regeneration solvent, particularly under conditions involving supercritical carbon dioxide, optimizing its efficacy for PFAS removal and recovery. The one or more polyelectrolytes also support miscibility switches in the regeneration solution, aiding in phase transitions such as converting the solvent phase to an anti-solvent phase for effective PFAS separation. Polyelectrolytes improve the efficiency, adaptability, and environmental compatibility of the regeneration process. In some embodiments, the polyelectrolyte included in the regeneration solution may include, but is not limited to, one or more of epichlorohydrin dimethylamine (epiDMA), poly (diallyldimethylammonium chloride) (polyDADMAC), polyacrylamide, polyphthalamide, poly (allylamine hydrochloride) (PAH), pectin (polygalacturonic acid), alginates, carboxymethyl cellulose, chitosan (CS), carrageenan, and nucleic acids.

The CO₂ is included in the regeneration process because it facilitates the transfer of PFAS from the fluorinated media to the solvent phase. When pressurized and heated above its critical point (e.g., 31.1° C. and 1,071 psi), carbon dioxide transitions into a supercritical state, exhibiting enhanced diffusivity and solvation properties that improve the desorption of PFAS from the fluorinated media. Carbon dioxide can be used to induce miscibility of mixtures to produce a homogenous medium, even in polar solutions. When scCO₂ is present in a mixture, it has the ability to make a fluorophobic solution (e.g., water) become more fluorophilic, can act as both a weak Lewis acid and Lewis base, and then the phase solubility can be reversed with a pressure reduction of the system. The o value of CO₂/scCO₂ is dependent on pressure and temperature (e.g., typically in range of 5-20). Its fluorophilic nature gives it a strong affinity for fluorinated compounds, such as PFAS, making it an effective medium for capturing and concentrating these substances. Additionally, the solubility of PFAS in carbon dioxide can be reversed by adjusting the pressure and temperature, allowing for the separation of PFAS from the solvent phase in downstream processes. Carbon dioxide also acts as a miscibility switch inducer, transforming the regeneration solution into an anti-solvent phase when combined with other components, such as water and pH adjustment reagents. This phase change facilitates the separation and recovery of PFAS in a concentrated form. Furthermore, carbon dioxide is described as a sustainable and environmentally friendly solvent, offering a desirable alternative to traditional organic solvents while maintaining compatibility, for example, with NSF/ANSI certifications for potable water applications. These attributes make carbon dioxide a central component of the process, enabling efficient PFAS desorption, concentration, and recovery with an environmentally sustainable approach.

In some embodiments, an acidic agent may be added to the regeneration solution to reduce the pH. In some embodiments, an alkaline agent may be added to the regeneration solution to increase the pH. In some embodiments, the temperature of the regeneration solution may be elevated. In some embodiments, the temperature of the regeneration solution may be decreased. In some embodiments, the pressure of the regeneration solution may be elevated. In some embodiments, the polyelectrolyte functions as a phase transfer catalyst. In some embodiments, the polyelectrolyte can be activated or deactivated based on the solution chemistry. In some embodiments, the polyelectrolyte comprises an electrostatic charge (e.g., the polyelectrolyte may comprise a cationic charge). In such embodiments, the charge may be maintained over a broad pH range, but can be activated and deactivated based on solution chemistry. In some embodiments, the polyelectolyte may be activated or deactivated based on solution temperature. In some embodiments, the polyelectrolyte is activated or deactivated based on whether the regeneration solution is functioning as an extraction medium or an anti-solvent.

In some embodiments, the water content of the extraction medium is <50 wt %, <25 wt %, <15 wt %, <10 wt %, <5 wt %, or <1 wt %. An extraction medium in the contact reactor may form an emulsion. The extraction medium may be an aqueous CO₂/sc-CO₂ phase. In some embodiments, the moisture content of the extraction medium is increased such that upon regeneration solution property changes to an anti-solvent (e.g., depressurization), the regeneration solution volume is reduced. In some embodiments, the regeneration solution (11) comprises one or more of the following: water, polyelectrolytes, polyacrylamides, polyamides, polyphthalamide, cationic polyelectrolytes, anionic polyelectrolytes, polydiallyldimethyl ammonium chloride (polyDADMAC), epichlorohydrin dimethylamine (epiDMA), quaternary polymers, PDMDAAC, carbon dioxide, supercritical carbon dioxide, ferric chloride, acetic acid, ferric chloride, ferric sulfate, ferrous chloride, ferrous sulfate, aluminum sulfate, calcium carbonate, calcium chloride, citric acid, hydrochloric acid, hydrofluorosilicic acid, hydrogen peroxide, ammonium sulfate, magnesium chloride, peracetic acid, phosphoric acid, poly aluminum chloride, f-solvents, organic solvents, polyorthophosphate, potassium hydroxide, sodium hydroxide, sodium carbonate, sodium bisulfite, sodium aluminate, sodium borohydride, sodium chloride, sodium permanganate, activated silica, moringa oleifera, sodium silicate, sulfuric acid, zinc-based compounds, zinc orthophosphate, and blended phosphates.

The PFAS regeneration solution may be tunable based on the state of the CO₂ in the regeneration solution, which changes with conditions (e.g., temperature and pressure) in the system. The regeneration solution may become an anti-solvent through a change in miscibility triggered by depressurization and/or the addition of a basic pH adjustment reagent. The addition of a basic or alkaline reagent increases the pH for the regeneration solution thereby altering the regeneration solution to behave as an anti-solvent. In some embodiments, a reagent may be added to decrease the pH for the regeneration solution to become an anti-solvent. The anti-solvent state of the regeneration solution may comprise aqueous carbon dioxide gas with a polyelectrolyte and alkaline additives.

TABLE 1
Summary of Solubility Parameters for Regeneration
Solution Combination Example

| | | Supercritical | | | |
|---|---|---|---|---|---|
| | PFAS | CO₂ | Polyelectrolyte | | |
| Structure | Plurality | CO₂/H₂CO₃ | polyDADMAC | epi-DMA | Polyacrylamide |

| | | | |
|---|---|---|---|
| Polarity | Amphiphilic | Non-polar | Polar |
| δ (MPa^{1/2}) | 5-20 | 5-20 | 15-30 |
| (Estimate) | | | |

Table 1 provides an exemplary composition of a regeneration solution effective for a plurality of applications, including in the examples and implementations described in the detailed description of the invention section herein. In some embodiments and implementations, the regeneration solution may include further constituents providing additional functionalities that may enhance the efficacy of the regeneration solution.

In some embodiments, the regeneration solution further comprises a fluorous phase. In some embodiments, the fluorous phase comprises a fluorous solvent (F-solvent). In further embodiments, the regeneration solution further comprises an organic solvent. An F-solvent with an organic solvent modifier may be considered for the application for recovery of compounds. Fluorous solvents exhibit a high affinity for fluorinated compounds, such as PFAS, due to the “like dissolves like” principle, facilitating the efficient transfer of PFAS from the fluorinated media or impacted matrix to the regeneration solution. The fluorous solvent also acts as a medium to concentrate PFAS into a separate phase, enhancing the efficiency of downstream separation, recovery, or destruction processes. Its immiscibility with water and organic solvents allows for phase separation during the PFAS recovery step, as the PFAS-enriched fluorous phase can be isolated from other solution components. Additionally, the fluorous solvent may work synergistically with supercritical carbon dioxide, improving the desorption of PFAS under the elevated pressure and temperature conditions of the regeneration process. The fluorous solvent is also recoverable and reusable, allowing it to be regenerated after PFAS removal for subsequent cycles, which reduces waste and operational costs. In some embodiments, the fluorous solvent may be included in the regeneration solution and may include, but is not limited to, one or more of perfluoroalkanes, perfluorinated ethers/polyethers, fluorinated surfactants, benzotrifluoride, Fluorinert™ Liquid FC-72, Novec™ HFE-7100 engineered fluid, Novec™ HFE-7500 engineered fluid, perfluorohexane, perfluorotributylamine, perfluoropolyether, perfluorodecaline, 1H, 1H,2H,2H-perfluorooctyltriethoxysilane, 1H, 1H,2H,2H-perfluorodecyltriethoxysilane, fluorotelomer thioamide sulfonates, fluorotelomer thiohydroxy ammonium, fluorotelomer sulfonamido betaines, and fluorotelomer sulfonamido amines.

Fluorous solvents are immiscible in water and organics. Compounds with perfluoroalkyl chains (PFAS) have high affinities towards fluorous solvents due to their inherent interactions and similar characteristics (“like dissolves like”). In some embodiments, catalysts or trapping agents can also be introduced to facilitate the removal mechanism for PFAS from the impacted matrices. In some embodiments, trapping agents can include additional reagents to influence or take advantage of the compound's electrostatic interactions, tune solvent properties, or through other means. In some embodiments, multiphase systems can also be used to separate PFAS compounds from impacted matrices and to recycle reagents.

In some embodiments, trapping agents may be included in the regeneration solution and may include, but is not limited to, one or more of zero-valent metals, ferric salts (e.g., ferric chloride, ferric sulfate, and other), ferrous chloride, activated carbon, chelating agents (e.g., EDTA), fluorinated surfactants (e.g., perfluorooctane sulfonamides), polyaluminum chloride, silver nanoparticles, chitosan, cyclodextrins, aluminum oxides, aluminum hydroxides, aluminum sulfate, zirconium oxides, zirconium hydroxides, zirconium salts, zirconium silicates, and other appropriate materials. For example, zero valent iron (ZVI, Fe²⁺) may or may not be introduced into the mixture to take advantage of the electrostatic interactions of the compounds. In some embodiments, the regeneration solution may further include a metal salt such as as ferric chloride, ferrous chloride, ferric sulfate, polyaluminum chloride, aluminum sulfate, and/or a combination thereof and may be used to increase the presence of positively charged constituents such as metal ions to enhance electrostatic interactions between the regeneration solution constituents and PFAS. In some embodiments, amendments are added to the regeneration solution to increase the hydrophilicity of the PFAS compounds and/or modify the structure of the PFAS compounds (e.g., amendment addition to carry out defluorination reactions such as oxidants, reductants, etc.).

In some embodiments, the PFAS removal or concentration process can occur at ambient conditions, or it can occur at an elevated temperature and/or pressure to enhance solubility characteristics of the F-solvent and PFAS-impacted matrices. In some embodiments, the process may be operated continuously or as a batch process depending on the PFAS-contaminated matrices requiring treatment.

In some embodiments, a fluorous solvent may be used to selectively remove PFAS compounds from both aqueous and solid matrices and is then separated from the matrices using an extraction process through the formation of a phase separated fluorous layer (fluorous biphasic solvent system, “FBS”). In some embodiments, supercritical CO₂ may be a reaction medium to enhance mass transfer and phase separation: i.e., to enhance and reverse solubility. In some embodiments, the solvent extraction process and system entails mixing the PFAS-impacted matrices with a fluorous solvent for an appropriate residence time that results in at least partial PFAS removal from the impacted matrices, and then sending the PFAS concentrated fluorous solvent and treated matrices to a settling/separation stage where the treated matrices are separated from the PFAS-concentrated F-solvent. The concentrated PFAS-fluorous solvent is both recirculated back upstream to the PFAS-impacted matrices and then conveyed downstream to a destruction/mineralization or recovery process. The selected F-solvent system will depend on the particular PFAS contaminated matrices, any potential upstream treatment processes, any potential downstream treatment processes, and the treatment goals for the PFAS-impacted matrices. In some embodiments, a fluorinated solvent (surfactant) may be used for foam fractionation pretreatment processes. In some embodiments, the fluorous phase comprises a fluorinated solid support. The solid support can be any solid material. In some embodiments, the solid support comprises a fluorinated silica grafted on a solid support.

In some embodiments, the presently disclosed methods can include a pretreatment/concentration stage or polishing stage for any PFAS-impacted matrices that require treatment prior to discharge/release and/or for recovery. The fluorinated silica media may be loaded into a pressure vessel, packed bed, column, or other contactor. In some embodiments, a pretreatment system may be utilized for the PFAS-impacted source depending on (water/vapor) quality characteristics, treatment goals, and media properties. In some embodiments, examples of pretreatment may include, but are not limited to pH adjustment, removal of competing species, and/or may even consider the use of another adsorption media prior to the fluorinated silica media vessel.

In some embodiments, the presently disclosed method may include treating PFAS-impacted phase (e.g., contaminated water) that is pumped to a pressure vessel and flows down through a media contactor. In other embodiments, the media contactor may have an upflow design where the PFAS-impacted water is pumped up through the contactor. In other embodiments, the PFAS-impacted matrices may flow down via gravity through the media contactor, or if the PFAS-impacted matrix is a gas, it may flow upward through the media contactor. In some embodiments, there may be multiple media vessels operating in parallel or series. In the media contactor vessel, the PFAS-impacted phase has a sufficient empty bed contact time (EBCT) so that at least part of the PFAS compounds are adsorbed to the media prior to leaving the contactor. In some embodiments, for a downflow configuration, the treated phase flows out of the bottom of the vessel and may be monitored to ensure sufficient removal rates.

After the media reaches its adsorption capacity for PFAS or a targeted capacity (e.g., to ensure there is no breakthrough of contaminants), a regeneration sequence may be performed. In some embodiments, the regeneration sequence desorbs the PFAS compounds from the media and produces a highly concentrated low volume stream for an appropriate PFAS destruction/mineralization or recovery process. In some embodiments, to desorb the PFAS compounds from the fluorinated media, one or more reagent(s) (e.g., a regeneration solution) flows into the vessel to remove the adsorbed PFAS compounds. In some embodiments, the pressure and temperature of the vessel can be increased, and supercritical CO₂ may be sparged into the vessel to enhance the solubility/partitioning of the PFAS compounds into the regeneration solution. In some embodiments, the reagent combination may include one more more of a polyelectrolyte, a fluorous solvent, supercritical carbon dioxide, an organic solvent, and a pH agent to modify the regeneration solution. In some embodiments, the pH of the regeneration solution is decreased so that the PFAS are not in their ionized form to enhance partitioning to the regeneration solution.

In some embodiments, the PFAS extraction process entails pressurizing and heating the PFAS impacted matrix to a contact reactor where CO₂ is introduced at supercritical conditions. In some embodiments, an F-solvent and/or other reagent(s) (i.e., comprising a regeneration solution) may be introduced to enhance removal of PFAS from the impacted matrix. In some embodiments, the PFAS contaminated matrix, supercritical CO₂, and F-solvent/Reagent(s) are in contact for an appropriate residence time that results in PFAS transfer from the impacted matrix phase to the F-solvent/Reagent(s) phase (i.e., treatment of the impacted matrix phase). In some embodiments, the solution is conveyed to a separation stage where depressurization occurs, and the solubility is reversed. In some embodiments, the treated impacted matrix phase and PFAS concentrated F-solvent/Reagent(s) form separate layers in the separation stage due to density differences and can be separated. In some embodiments, the treated impacted matrix phase can then undergo further treatment or be discharged. In some embodiments, the PFAS concentrated F-solvent/Reagent(s) phase can either be recirculated back to the contact reactor or be sent to additional treatment processes.

It is to be appreciated that the regeneration solution (11) and fluorous phase may be dependent on the application and goals for the process (e.g., recovery of various compounds, extraction for destruction, etc.). It is to be appreciated that the selected system operation conditions (temperature, pressure, etc) and reagent(s) will depend on the PFAS contaminated matrices, any potential treatment upstream, any potential downstream treatment processes, and the treatment goals for the PFAS-impacted matrices. Subsequent sections discuss in more detail the various embodiments and applications.

A summary of the methods and systems for the removal, concentration, and recovery of PFAS from a PFAS-impacted phase is disclosed in Section 1 with the use of fluorous biphasic and/or multiphasic system(s). A fluorous fractionation reactor and methods to separate and concentrate PFAS is disclosed in Section 1. The subsequent sections disclose a plurality of embodiments of the use of fluorous biphasic and/or multiphasic systems and methods.

Embodiments for a multiphasic system for the removal, concentration, and recovery of PFAS from a PFAS-impacted aqueous and/or vapor phase is disclosed in Section 2 with the use of packed bed contact reactors in series (e.g., adsorption pretreatment process).

Embodiments for a multiphasic system for the removal, concentration, and recovery of PFAS from a PFAS-impacted aqueous phase is disclosed in Section 3 with a stripping contact reactor and packed bed contact reactor in series (e.g., foam fractionation pretreatment process).

Embodiments for a multiphasic system for the removal, concentration, and recovery of PFAS from a PFAS-impacted phase is disclosed in Section 4 with a liquid/liquid extraction contact reactor and packed bed contact reactor in series.

Embodiments for a multiphasic system for the removal, concentration, and recovery of PFAS from a PFAS-impacted phase is disclosed in Section 5 with a packed bed reactor.

Embodiments for a multiphasic system for the removal, concentration, and recovery of PFAS from a PFAS-impacted phase is disclosed in Section 6 with a stripping contact reactor, liquid/liquid extraction contact reactor, and packed bed reactor in series (combining elements from Section 2, Section 3, and Section 4).

Although this disclosure focuses on these embodiments, it is not intended to limit the applications. In addition, any disclosures in any Sections can be used in combinations.

It is an object of the present invention to provide a method for removing PFAS from contaminated solid phases using an extraction medium that is compatible with NSF/ANSI certifications for potable water.

It is another object of the present invention to enhance the efficacy of PFAS removal and concentration processes by reducing the sensitivity of the process to co-contaminants.

It is another object of the present invention to permit the recovery of PFAS for re-use in lieu of disposal and/or destruction methods.

It is another object of the present invention to provide an extraction medium that can supplement pretreatment processes to enhance their PFAS removal and concentration.

It is another object of the present invention to enhance the removal of ultra- and/or short chain PFAS compounds.

It is another object of the present invention to enhance the concentration of PFAS to reduce the volume of wastewater residuals, improve process economics, and reduce liabilities associated with the handling of the materials.

It is another object of the present invention to enhance the uniformity of the matrix characteristics of the PFAS-concentrated phase to enhance the efficacy of downstream waste/wastewater management process such as destruction/mineralization treatment processes.

Further aspects and embodiments will be apparent to those having skill in the art from the description and disclosure provided herein.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a block diagram of a method for the removal, concentration, and recovery of PFAS from a PFAS-impacted phase with a fluorous system, according to an embodiment of the invention.

FIG. 1a provides a block diagram of a method for the removal, concentration, and recovery of PFAS with a fluorous system comprising a contact reactor and regeneration solution, according to an embodiment of the invention.

FIG. 1b provides a block diagram of a method for the removal, concentration, and recovery of PFAS from a solid phase with a fluorous system comprising a series of contact reactors and regeneration solutions, according to an embodiment of the invention.

FIG. 1c provides a block diagram of a method for the removal, concentration, and recovery of PFAS with a fluorous system comprising a contact reactor and regeneration solution, according to an embodiment of the invention.

FIG. 1d provides a block diagram of a fluorous system with the use of CO₂, according to an embodiment of the invention.

FIG. 1e provides a block diagram of a fluorous system with the use of CO₂ as a batch process, according to an embodiment of the invention.

FIG. 1f provides a block diagram of a fluorous system with the use of CO₂ as a continuous process, according to an embodiment of the invention.

FIG. 2 provides a process flow diagram of an embodiment of the fluorous system.

FIG. 3 provides a process flow diagram of an embodiment of the fluorous system comprising a contact reactor comprising a fractionation reactor.

FIG. 3a provides a process flow diagram of an embodiment of the fluorous system comprising a contact reactor comprising a fractionation reactor.

FIG. 4 provides a block diagram of an adsorption pretreatment process with a fluorous system, according to an embodiment of the invention.

FIG. 5 provides a process flow diagram of an adsorption pretreatment process with a fluorous system, according to an embodiment of the invention.

FIG. 6a provides a schematic of a scheme for an embodiment of the removal of PFAS from a solid phase.

FIG. 6b provides a schematic view of a scheme for an embodiment of the removal of PFAS from a solid phase.

FIG. 6c provides a schematic view of a scheme for an embodiment of the removal of PFAS from a solid phase.

FIG. 6d provides a schematic view of a scheme for an embodiment of the removal of PFAS from a solid phase.

FIG. 6e provides a schematic view of a scheme for an embodiment of the removal of PFAS from a solid phase.

FIG. 7 provides a block diagram of a foam fractionation pretreatment process with a fluorous system, according to an embodiment of the invention.

FIG. 8 provides a process flow diagram of a foam fractionation pretreatment process with a fluorous system, according to an embodiment of the invention.

FIG. 8a provides a provides a schematic of a scheme for an embodiment of the removal of PFAS from an aqueous phase.

FIG. 9 provides a block diagram of a LLE process, according to an embodiment of the invention.

FIG. 10 provides a process flow diagram of a LLE pretreatment process with a fluorous system, according to an embodiment of the invention.

FIG. 10a provides a provides a schematic of a scheme for an embodiment of the removal of PFAS from a solid phase.

FIG. 11 provides a process flow diagram of a packed bed reactor process, according to an embodiment of the invention.

FIG. 12 provides a block diagram of multiple pretreatment processes in combination with a fluorous system, according to an embodiment of the invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent that the present invention may be practiced without all of the specific details provided.

### Section 1. Fluorous Fractionation Reactor and Fluorous Biphasic and/or Multiphasic Systems and Methods

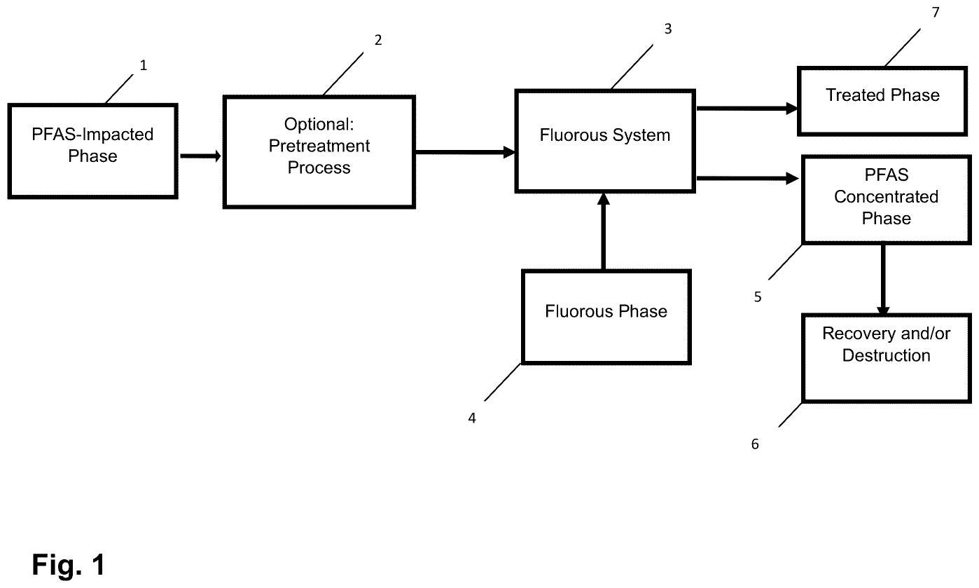

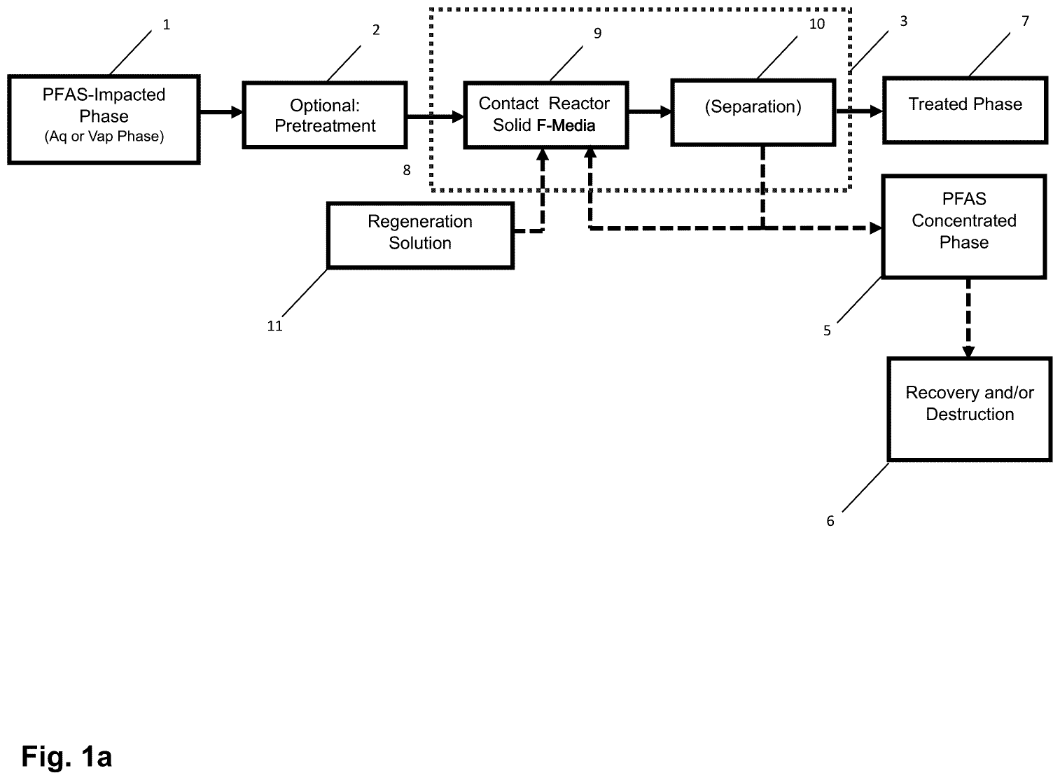

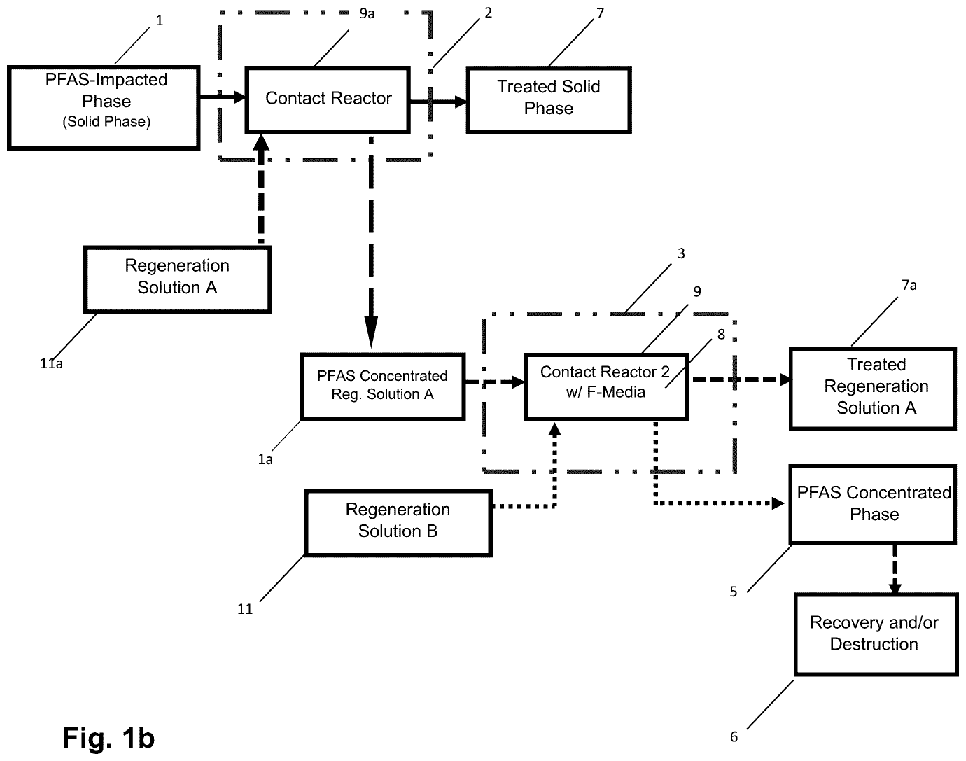

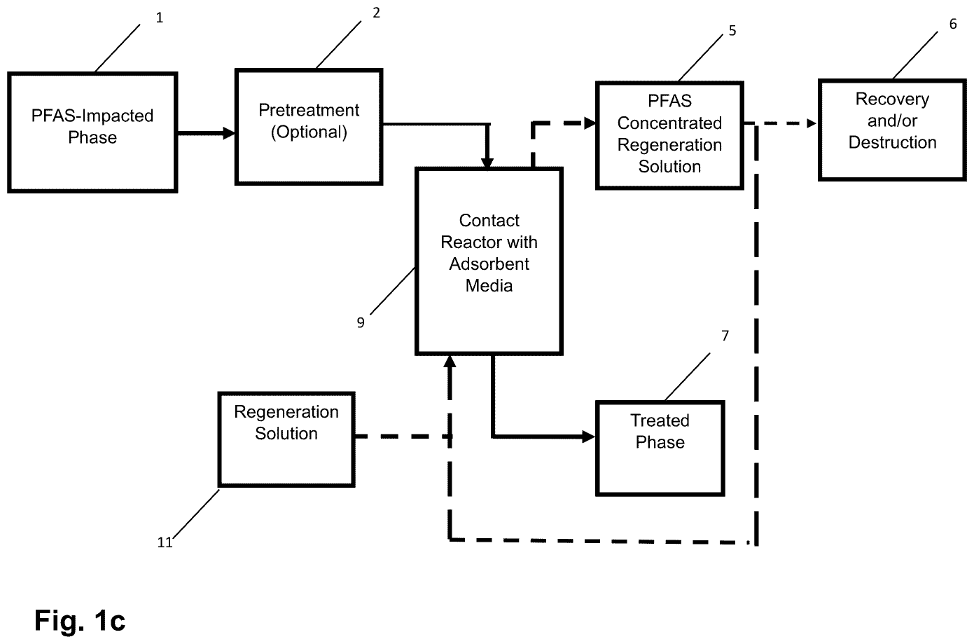

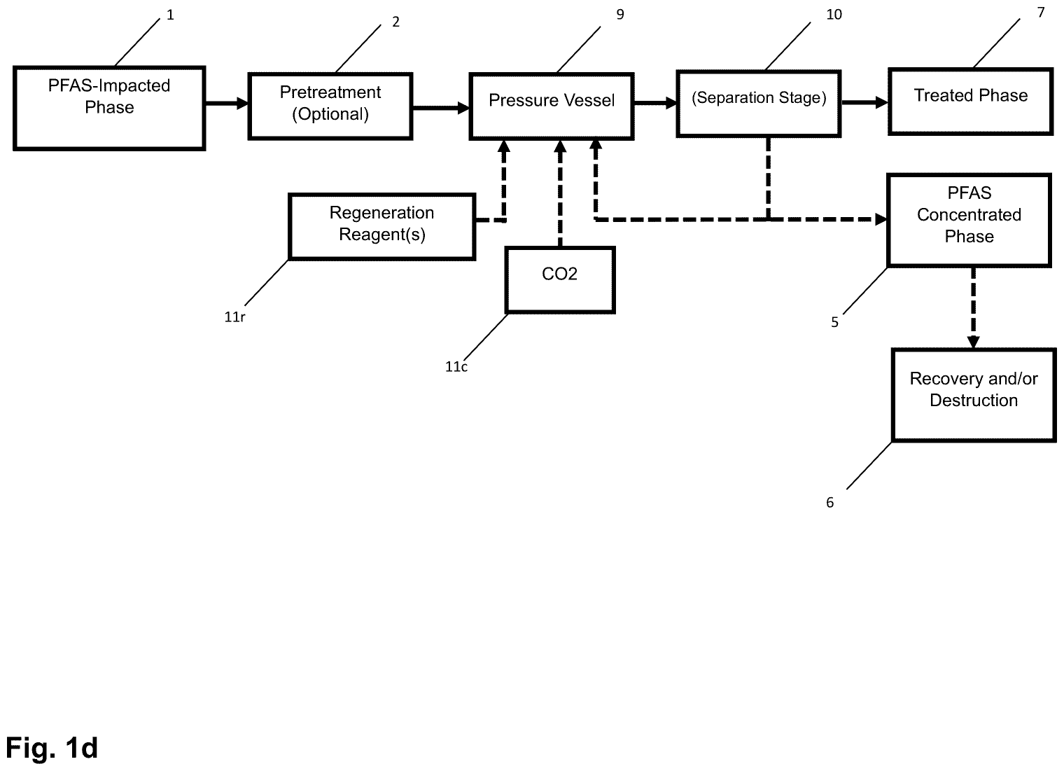

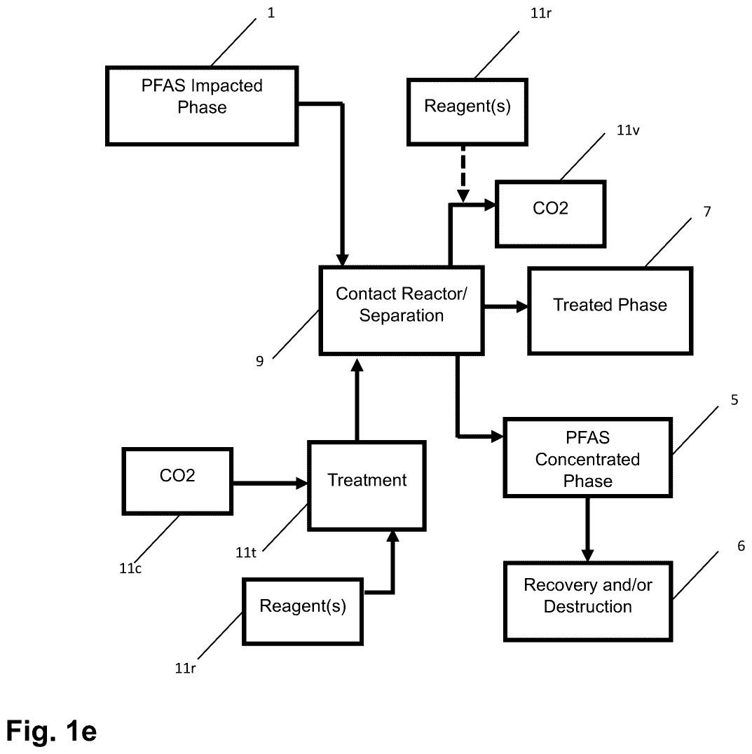

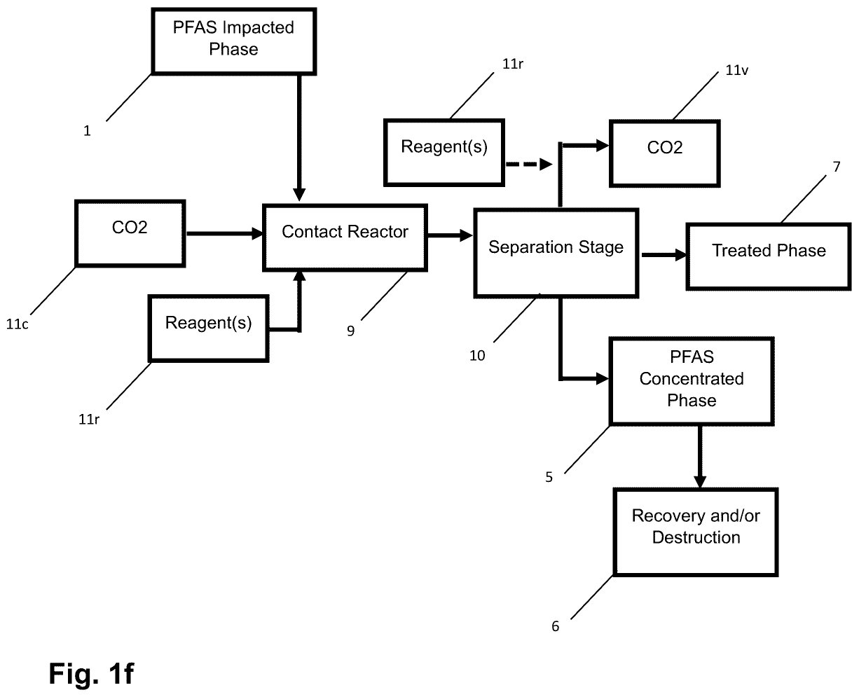

Referring to the drawings, wherein like reference characters designate like or corresponding parts throughout the several views, and referring first to FIGS. 1-3, it is seen that these figures depict exemplary embodiments of fluorous fractionation reactor and fluorous biphasic and/or multiphasic systems and methods.

As shown in the embodiment of FIG. 1, a PFAS-impacted phase (1) may be introduced to an optional pretreatment (2) process, wherein the physical, chemical, and/or thermal properties of the phase may be modified. The pretreatment process (2) may further comprise a PFAS separation method, such that part of the PFAS may be separated from other contaminants in the PFAS-impacted phase and concentrated in a PFAS-impacted concentrate phase. The PFAS-impacted phase and/or PFAS-impacted concentrate phase is then introduced to a biphasic or multiphasic fluorous system (3) having a fluorous media (e.g., fluorinated solid media) to capture PFAS from the PFAS-impacted concentrate, a fluorous phase (e.g., a fluorous regeneration solution) (4) may be introduced and PFAS is transferred from the fluorous media to the fluorous phase (i.e., concentrated in a PFAS-concentrated phase (5) for subsequent recovery through a PFAS removal method or waste disposal (6). As PFAS is removed from the PFAS-impacted phase or PFAS-impacted concentrate phase, the impacted phase(s) then become a treated phase (7), from which at least part of the PFAS is removed from the impacted phase(s).

FIG. 1 provides a generalized schematic of a PFAS removal method and systems disclosed and discussed herein. It provides generalized categories of elements and constituents of the process. The PFAS-impacted phase (1) may comprise an aqueous, vapor, organic, and/or solid phase. The PFAS-impacted phase can be any source containing PFAS compounds, as defined herein.

In some embodiments, the PFAS-impacted phase (1) to be treated is selected from the following list: industrial wastewater, leachate, landfill leachate, aqueous film forming foam (AFFF), municipal wastewater, primary wastewater, secondary wastewater, tertiary wastewater, foam fractionation residuals, brine, resin regeneration byproduct streams or brine, activated carbon regeneration byproduct streams, novel sorbent regeneration byproduct streams, groundwater, drinking water, drinking water residuals, stormwater, semiconductor wastewater, chemical manufacturing wastewater (primary and secondary manufacturing), metal finishing and plating wastewater, textile wastewater, paper products wastewater, petroleum industry wastewater, steel industry wastewater, aluminum industry wastewater, food and beverage wastewater, biosolids, membrane concentrates, thermal desorption condensate, scrubber wastewater, stack emission wastewater, soil wash water, aqueous based solid slurries such as activated carbon, ion-exchange resin, soils, and precipitated solids from chemical reactions, or a combination thereof.

In any of these embodiments for the PFAS-impacted phase (1), a plurality of inorganic species may be present in any form and in combination such as sulfate, bicarbonate/carbonate, chloride, silica, magnesium, calcium, iron, mercury, cadmium, zinc, aluminum, copper, cobalt, sodium, arsenic, barium, borate, bromide, fluoride, lead, lithium, manganese, nitrate, nitrite, phosphate, selenium, potassium, strontium, suspended matter, biological matter, hydrogen sulfide, and/or ammonia.

In some embodiments, prior to the fluorous biphasic and/or multiphasic system, the PFAS impacted phase (1) is pretreated (2) to remove other contaminants and/or other constituents in the impacted phase (1). The pretreatment option is dependent on the impacted phase characteristics. Various pretreatment options could comprise, but are not limited to coagulation, flocculation, filtration, adsorption (e.g., activated carbon, ion-exchange, etc), membrane separation (e.g., reverse osmosis, nanofiltration, ultrafiltration, electrodeionization, etc), deaeration, chemical precipitation, disinfection, aeration, pH adjustment (i.e., increase or decrease), temperature adjustment (i.e., heating or cooling), foam fractionation, clarification, dilution, gravity sedimentation or settling, centrifugal sedimentation, dissolved air flotation, thickening, wet scrubbing, mechanical dewatering, absorption processes, electrochemical processes, liquid/liquid extraction processes, solid/liquid extraction processes, chemical catalyst regeneration, crystallization, magnetic fields, chemical oxidation, chemical reduction, oxidant/oxygen scavenging, natural treatment systems, UV treatment, distillation, stripping, humidity/gas drying control, moisture removal, activated alumina processes, metal recovery, or a combination thereof. Various pretreatment options for PFAS removal could comprise adsorption, foam fractionation, ion-exchange, and other processes. In some implementations, the pre-treatment may be performed in a reaction vessel with a fluorinated solvent to capture and concentrate PFAS in a concentrated PFAS phase. In other implementations, the pre-treatment may be performed with a solution that includes polyelectrolytes as defined herein and CO₂, where increased pressure and temperature are applied to create supercritical CO₂ in the pretreatment in a reaction vessel for pretreatment to aid in the separation and concentration of PFAS. In such embodiments, the solution may further include a fluorinated solvent. For PFAS removal pretreatment options, a PFAS-concentrated phase from the PFAS pretreatment can be fed to the fluorous biphasic and/or multiphasic system (3), or the fluorous biphasic and/or multiphasic system could be used as a polishing stage for the PFAS-impacted phase after a PFAS removal pretreatment option.

In some embodiments, the fluorous phase (4) may comprise a fluorinated solid support (F-media) (8) and/or a fluorinated solvent (F-solvent). The selection of the fluorinated solid support and/or fluorinated solvent is dependent on the characteristics of the PFAS-impacted phase. In some embodiments, the solid support comprises silica, aluminum oxide, zero valent iron, another metal oxide, or other solid support as disclosed herein. The solid support may be in the form beads, pellets, chips, fibers, shells, and/or nanoparticles.

In some embodiments, fluorinated silica is grafted on a solid support. In some embodiments, the fluorinated silica that is grafted on the solid support contains the base structure of Si—O—Si—R or M-O—Si—R where R can contain a variety of fluorous functional groups/species and M is a metal oxide support or other material. The R structure can include one or more of the following, but is not limited to, fluorinated functional groups that contain alkyl, alkenyl, alkynyl, arene, halogens, haloalkane, alcohol, acyl halide, ester, ether, epoxide, amine, amide, amido, azide, amino, urea, nitrate, nitrite, nitrile, nitro, aldehyde, ketone, carbamates, carboxylic acid, carboxy ester, acid anhydride, nitroso, imine, imide, azide, cyanate, isocyanate, azo compound, thiol, sulfide, disulfide, sulfoxide, sulfone, sulfinic acid, sulfonic acid, sulfonate ester, sulfonyl, sulfonamide, thiocyanate, isothiocyanate, thial, thioketone, phosphine, carbocyclyl, heterocyclyl, heteroaryl, acyl, or others groups, perfluoroalkanes, perfluorinated trialkylamines, perfluorinated ethers/polyethers, fluorinated surfactants, benzotrifluoride, Fluorinert™ Liquid FC-72, Novec™ HFE-7100 engineered fluid, Novec™ HFE-7500 engineered fluid, perfluorohexane, perfluorotributylamine, 1H, 1H,2H,2H-perfluorooctyltriethoxysilane, 1H, 1H,2H,2H-perfluorodecyltriethyoxysilane, perfluoropolyether, perfluorodecaline, perfluorohexane, Teflon, fluorotelomer thioamide sulfonates, fluorotelomer thiohydroxy ammonium, fluorotelomer sulfonamido betaines, fluorous triphenylphosphine, fluorous DEAD, fluorotelomer sulfonamido amines, fluoroacetic acid, Selectfluor™, SynFluor™, fluorobenzene, fluorobenzoic acid, fluorocyclohexane, 1-fluoroethyl cation, fluorotelomer betaines, perfluoroalkyl sulfonamido amines, perfluoroalkyl sulfonamide amino carboxylates, NFPy, DiCl-NFPy, triMe-NFPy, pyrrolidinium cations, fluorinated pyridinium, fluorinated ammonium, fluorous triphenylphosphine, and others that may comprise the structure in part or in whole of the fluorous solid phase. In some embodiments, the fluorous phase fluorine content comprises >5 wt %, >10 wt %, >20 wt %, >30 wt %, >50 wt %, >60 wt %, or >75 wt %.

In some embodiments, the fluorous functional groups comprise strong, basic functional groups. In a slightly preferred embodiment, the fluorous functional groups comprise weak, basic functional groups. In a preferred embodiment, the fluorinated silica comprises at least one cationic fluorinated functional group. In other embodiments, the fluorinated solid support comprises a nitrogen-heterocyclic group. In some embodiments, the fluorinated functional group comprises an alkane, alkylamine, ether, amine, aniline, pyridium, imidazole, isocyanate and/or combination thereof. In further embodiments, the fluorinated solid support comprises a pyridium functional group. In some embodiments, the fluorinated solid support is synthesized with perfluoroalkylsilane-based structures via condensation with the substitution of the hydroxyl groups with reactive groups of the perfluoroalkylsilane compounds.

The F-solvent may be used as the fluorous phase or in combination with a fluorour solid phase contains mixed fluorinated chains. Fluorous (e.g., fluorinated) solvents can include one or more of the following, but are not limited to, fluorinated compound(s) that contain one or more of the following functional groups alkyl, alkenyl, alkynyl, arene, halogens, haloalkane, alcohol, acyl halide, ester, ether, epoxide, amine, amide, amido, azide, amino, urea, nitrate, nitrite, nitrile, nitro, aldehyde, ketone, carbamates, carboxylic acid, carboxy ester, acid anhydride, nitroso, imine, imide, azide, cyanate, isocyanate, azo compound, thiol, sulfide, disulfide, sulfoxide, sulfone, sulfinic acid, sulfonic acid, sulfonate ester, sulfonyl, sulfonamide, thiocyanate, isothiocyanate, thial, thioketone, phosphine, carbocyclyl, heterocyclyl, heteroaryl, acyl, or others groups; perfluoroalkanes, perfluorinated trialkylamines, perfluorinated ethers/polyethers, fluorinated surfactants, benzotrifluoride, Fluorinert™ Liquid FC-72, Novec™ HFE-7100 engineered fluid, Novec™ HFE-7500 engineered fluid, perfluorohexane, perfluorotributylamine, perfluoropolyether, perfluorodecaline, perfluorohexane, Teflon, fluorotelomer thioamide sulfonates, fluorotelomer thiohydroxy ammonium, fluorotelomer sulfonamido betaines, fluorous triphenylphosphine, fluorous DEAD, fluorotelomer sulfonamido amines, fluoroacetic acid, Selectfluor, Synfluor, fluorobenzene, fluorobenzoic acid, fluorocyclohexane, 1-fluoroethyl cation, fluorotelomer betaines, perfluoroalkyl sulfonamido amines, perfluoroalkyl sulfonamide amino carboxylates, NFPy, DiCI-NFPy, triMe-NFPy, pyrrolidinium cations, fluorinated pyridinium, fluorinated ammonium, fluorous triphenylphosphine, and others. The number of carbon and fluorine can vary, but must be at least one for each compound. In a preferred embodiment, the F-solvent mixture would include at least one cationic fluorinated compound. Reagents can be procured commercially or synthesized. In some embodiments, the fluorous functional group comprise a nitrogen-heterocyclic group. In some embodiments, the fluorous phase fluorine content comprises >5 wt %, >10 wt %, >20 wt %, >30 wt %, >50 wt %, >60 wt %, or >75 wt %.

In some embodiments, the fluorinated solvent can be used in combination with other compounds such as fluorous scavengers, amphiphilic solvents, organic solvents, ionic constituents/solutions (salts), common acid/bases, zero valent metals (ZVI, etc), silica, surfactants (cationic and/or anionic), and/or supercritical CO₂ to enhance removal mechanisms. In some embodiments, the fluorinated silica media can be used in combination with other compounds such as fluorous solvents, fluorous scavengers, amphiphilic solvents, organic solvents (methanol, ethanol, isopropanol, pentane, hexane, heptane, octane, nonane, decane, benzene, toluene, xylene, ether, ethyl acetate, triethylamine, tripropylamine, acetone, acetonitrile, acetamide, diethyl ether, THF, ethylene carbonate, dimethylsulfone, dimethylsulfoxide, etc), ionic constituents/solutions (salts, sodium chloride, calcium chloride, potassium chloride, ammonium fluoride, magnesium carbonate, iron hydrogen phosphate, magnesium sulfate, sodium bisulfate), common acid/bases (citric acid, sodium hydroxide, potassium hydroxide, ammonium hydroxide, phosphoric acid, sulfuric acid, hydrochloric acid, nitric acid, etc), zero valent metals (ZVI, etc), nitrogen/argon/etc, surfactants (cationic, anionic, etc), phospholipids, and/or supercritical CO₂ to enhance media preparation/grafting processes, PFAS sorption/desorption mechanisms, and other means.

In the generalized schematic of FIG. 1 and generally in the systems and methods discussed herein, a PFAS-impacted aqueous matrix (1) and F-solvent/reagent(s) may be filtered and pumped to a pressure vessel, such as a continuous stirred-tank reactor (CSTR) and maintained at >1100 psi and >31 deg C. The contact of the PFAS-impacted phase with the F-media results in the adsorption of the PFAS to the F-media such that at least a portion of the PFAS present in the impacted phase is removed from the impacted phase. This can be referred to as a PFAS Removal Step, in which PFAS is removed from the PFAS-impacted phase. The mixture may be circulated or agitated in order to promote interaction of the PFAS with the F-media. Heating may be supplied through the recovery of heat from other processes or through electrical or chemical means.

After a predetermined period of time, the PFAS-impacted phase (aqueous phase) can be removed from the reaction as at least a portion of the PFAS is removed from the PFAS-impacted phase to yield a treated phase (7). This marks the end of the PFAS Removal Step.

In other embodiments, the PFAS Removal Step may include additional processes. In some embodiments, a PFAS-impacted aqueous matrix (1) and a F-solvent and optional additional reagent(s) as described herein may be filtered and pumped into a pressure vessel operating as a CSTR and maintained at >1100 psi and >31 deg C. Heating may be supplied through the recovery of heat from other processes or through electrical or chemical means. Supercritical CO₂ may be introduced into the pressure vessel (e.g., by sparging). The impacted phase, the F-solvent, and the supercritical CO₂ may be mixed for an appropriate residence time that results in at least partial mobilization and transfer of the PFAS compounds to the F-solvent phase. Following the adequate residence time, the pressure in the vessel may be reduced to reverse the solubility of the PFAS-impacted phase in the F-solvent.

The mixture may then enter a separation stage, in which the mixture may be transferred to a sedimentation or settling tank or a centrifuge. After adequate time for separation, the treated aqueous phase is decanted or otherwise drawn from the top of the separation vessel and discharged for further processing. The point of exit of the aqueous phase may not be immediately at the top of the tank as PFAS compounds tend to partition to air/water interfaces, so the pipe may be located beneath the surface of the phase, but above the fluorinated solvent layer. The concentrated fluorinated solvent (and any potential other reagent(s)) may be recirculated back to the CSTR for reuse and a portion of it is sent to a recovery and/or downstream destruction treatment process. If a solid reagent is added to enhance the reaction, a filter may be located downstream. This process can be operated as a batch, continuous, or semi-continuous process.

After the PFAS Removal Step is complete, a regeneration step may be performed to recapture PFAS contaminants from the F-media in the reactor and maintain and refresh the F-media for additional use. A regeneration solution may be added into the reactor and CO₂ may be sparged into the pressure vessel. The regeneration solution may include one or more polyelectrolytes as disclosed herein and water, and may be introduced into the reactor with CO₂. In some implementations, may further include a fluorous solvent as disclosed herein. The conditions in the reactor may be changed to promote the regeneration step, including an increase in temperature and/or pressure to provide conditions that generate supercritical CO₂. It is mixed for an appropriate residence time that results in mobilization of the PFAS compounds from the F-media to the regeneration solution phase. Following adequate residence time, a pressure control valve slowly reduces the pressure to remove conditions for supercritical CO₂ and reverse the solubility of the phases.

In the generalized schematic of FIG. 1 and generally in the systems and methods discussed herein, a PFAS-impacted solid matrix is maintained/loaded within a contact reactor and ready for extraction in batch processes. The contact reactor is heated to >31 deg C. and maintained at this temperature over the duration of the regeneration. CO₂ is pressurized to >1,100 psi, pre-heated >31 deg C., and conveyed to the contact reactor with the PFAS contaminated solid. Prior to pre-heating, the CO₂ may be cooled to facilitate its conveyance. An F-solvent and optionally additional reagent(s) as described herein may be mixed into the CO₂ prior to its injection into the contact reactor, or it may be injected directly into the contact reactor. The solution in the contact reactor is mixed, recirculated, and/or maintained for an appropriate residence time that results in the transfer of the PFAS from the impacted F-media to the F-solvent phase. After the residence time, the system is depressurized, and phase separation occurs. To control the system pressure, a back pressure regulator or other means may be used. At the top of the separation vessel, the CO₂ may be vented and/or recovered/reused. An additional Reagent(s) may or may not be injected into the CO₂ line prior to being vented or recovered and reused. The F-solvent phase is collected and processed for further treatment. Any reagents added to the F-solvent may also be recovered. The solid matrix is then treated and ready for further processing. If the solid matrix is an adsorbent media, then it can be reused to adsorb PFAS.

In some cases, a liquid F-phase may be used in combination with the solid F-media or as alternative fluorinated matrix. In such embodiments, the liquid matrix phase and the PFAS concentrated F-solvent/Reagent(s) phase may then be separate in the separation vessel. The PFAS concentrated F-solvent/Reagent(s) phase is collected and processed for further treatment. The treated liquid matrix phase is then collected and processed for further treatment and/or ready for discharge. In further embodiments, the liquid F-phase is an aqueous phase and the F-solvent/Reagent(s) phase then separate in the contact reactor or are conveyed to a separation vessel where the aqueous phase and the F-solvent/Reagent(s) phase separate. The aqueous phase is then collected and processed for further treatment and/or ready for discharge.

FIGS. 1a-3 provide illustrations of more specific fluorous biphasic and/or multiphasic systems. Referring to the embodiment of FIG. 1a, PFAS-impacted phase (1) is introduced to a fluorous system (3). In some embodiments, the fluorous system may comprise a fluorinated solid support (8), F-media as disclosed herein. In some embodiments, the fluorous system comprises a fluorous solvent, and F-solvent as disclosed herein. In some embodiments, the fluorous system comprises a fluorous solvent modified with an organic solvent.

For the purposes of discussion for FIG. 1a, a PFAS-impacted phase (1) and a fluorinated solid support (8) is introduced into a contact reactor (9), wherein the PFAS-impacted phase passes through the contact reactor (9), contacting the fluorinated solid support (8) to which PFAS in the impacted solution adsorbs and the treated impacted phase is then separated (10) from the fluorinated solid support (8).

In some embodiments, the contact reactor may comprise a packed bed reactor, continuously stirred tank reactor (CSTR), fluidized bed reactor, adsorption column, stripping column/reactor, or other means. The PFAS-impacted phase comprises an aqueous and/or vapor/gas phase. As PFAS is removed from the PFAS-impacted phase, the impacted phase then becomes a treated phase (7), from which at least part of the PFAS are removed. To extract PFAS from the fluorous media, a regeneration solution (11) is introduced to the fluorous system (3), contacts the fluorous media (8), and transfers at least part of the PFAS from the fluorinated solid support (8) to the regeneration solution (11). The extraction of the PFAS from the fluorous media (8) by the regeneration solution (11) may be facilitated or enhanced by the presence of CO₂ and reactor (9) conditions that create supercritical CO₂. The conditions in the reactor (9) may be changed to transition the process form the regeneration phase to a separation (10). The regeneration solution (11) creates two or more phases, where the PFAS are captured in the non-aqueous phase, which may be an F-solvent phase. The resulting aqueous treated phase (7) is removed and the remaining PFAS-concentrated phase (5) can be recovered or destroyed (6).

Referring to the embodiment of FIG. 1b, for a PFAS-impacted solid phase such as contaminated adsorption media, the PFAS is first extracted from the solid phase prior to being introduced to the fluorous system in a pretreatment step (2). As shown in FIG. 1b, a PFAS extraction medium (11) (regeneration solution) is introduced to a PFAS-impacted solid phase (1) in pretreatment step (2), where it contacts the solid phase in a contact reactor 9a (e.g., packed bed reactor), and at least part of the PFAS is transferred from the impacted solid phase to the regeneration solution (11), thereby producing a PFAS-concentrated extraction medium (i.e., PFAS-concentrated regeneration solution (1a)). As PFAS is removed from the solid phase, the solid phase becomes a treated solid phase (7). Similar to described for FIG. 1a, the PFAS-concentrated phase (PFAS-concentrated regeneration solution 1a) is introduced to a fluorous system (3), wherein the fluorous phase (8) comprises a fluorinated solid support (8) (e.g., solid F-media) and PFAS is removed from the concentrated extraction medium/phase (PFAS-concentrated regeneration solution 1a) and concentrated into the fluorous phase (8). As PFAS is removed from the PFAS-concentrated extraction medium/phase, the extraction medium/phase then becomes a treated medium/phase (7a) (i.e., treated regeneration solution (7a)), wherein at least part of the PFAS is removed from the treated regeneration solution A. To extract PFAS from the fluorinated media, a regeneration solution (11a) is introduced to the fluorous system (3), contacts the fluorous phase (8), and transfers at least part of the PFAS from the fluorinated solid support (8) to the regeneration solution (11a). As the PFAS transfers to the regeneration solution (11a), it becomes a PFAS-concentrated phase (5), wherein it can be recovered or destroyed (6).

FIG. 1c provides a block diagram that summarizes FIG. 1a and FIG. 1b for a PFAS-impacted phase (1), a contact reactor (9) with adsorbent fluorous media, a regeneration solution (11), and the subsequent treated phase (7) and PFAS-concentrated phase (5). The PFAS-concentrated phase (5) can optionally be cycled back into the Contact Reactor (9) to increase the concentration of PFAS in the PFAS-concentrated phase and/or reduce the quantity of regeneration solution introduced into the system (e.g., to recover the regeneration solution). The PFAS from the PFAS-concentrated phase can be optionally recovered for re-use in other processes or the PFAS-concentrated phase can be processed for degradation through various processes (e.g., supercritical water oxidation, electrochemical oxidation, incineration, other chemical degradation methods, etc.).

In some embodiments, the regeneration solution (11) comprises carbon dioxide. The carbon dioxide may be added to the contact reactor (9), which can provide supercritical conditions. In other embodiments, the CO₂ is pressurized and heated to supercritical conditions prior to be added to the contact reactor (9). FIG. 1d expands upon FIG. 1a-1c with the use of carbon dioxide (11c) as an addition to the regeneration solution (11r). In some embodiments, carbon dioxide may be used as part of the regeneration solution for the pretreatment process (2) and fluorous system (9). One or more additional regeneration reagent(s) may be used to supplement the regeneration solution (11r), such as a pH reagent and/or other reagents as disclosed herein. As shown in FIG. 1d, the contact reactor (9) may comprise a pressure vessel for embodiments that comprise the use of carbon dioxide as part of the regeneration solution.

FIGS. 1e and 1f illustrate embodiments for systems with regeneration solutions comprising carbon dioxide for batch and continuous processes, respectively. In some embodiments, carbon dioxide may be utilized as supercritical carbon dioxide. As shown in FIG. 1e, carbon dioxide (11c) and reagent(s) (11r) are introduced into a contact reactor (9) with a PFAS-impacted phase (1) for a batch process. In some embodiments, carbon dioxide (11c) and regeneration reagent(s) (11r) may be pretreated (11t) to condition the CO₂ to be in supercritical CO₂ form prior to being added to the contact reactor (9) with the PFAS-impacted phase (1). The pretreated regeneration solution is then added to the contact reactor and interacts with the PFAS-impacted phase (1). After appropriate contact time in the contact reactor (9) such that at least part of the PFAS is transferred from the impacted phase to a PFAS-concentrated phase, a separation step is performed, in which the treated phase (7) is separated from the PFAS-concentrated phase (5). In some embodiments, reagent(s) may be added prior and/or after phase separation. In some embodiments, the carbon dioxide may be vented (11v). In some embodiments, the carbon dioxide is part of the PFAS-concentrated phase (5). In some embodiments, reagent(s) may be added to the PFAS-concentrated phase (5) after phase separation to facilitate separation and recovery of fluorous solvent.

Similarly for a continuous process, as shown in FIG. 1f, carbon dioxide (11c) and reagent(s) (11r) are introduced into a contact reactor (9) with a PFAS-impacted phase (1). The contact reactor (9) may be pressurized and the temperature may be increased in order to provide condition to transition the CO₂ to supercritical condition. After appropriate contact time such that at least part of the PFAS is transferred from the impacted phase to a PFAS-concentrated phase, the mixture is conveyed to a separation stage (10), wherein the treated phase (7) is separated from the PFAS-concentrated phase (5). In some embodiments, reagent(s) may be added prior and/or after phase separation. In some embodiments, the carbon dioxide may be vented (11v). In some embodiments, reagent(s) may be added to the carbon dioxide that is vented (11v). In some embodiments, the carbon dioxide is part of the PFAS-concentrated phase (5). In some embodiments, reagent(s) may be added to the PFAS-concentrated phase (5) after phase separation to facilitate separation and recovery of fluorous solvent.

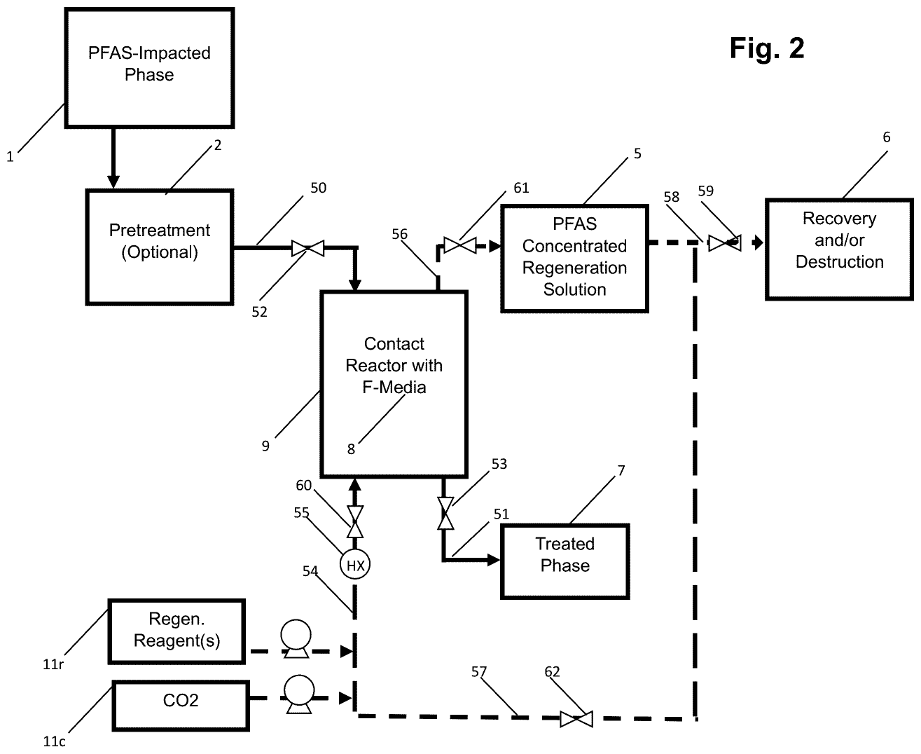

FIG. 2 provides a process flow diagram of an embodiment of the system such as that illustrated in FIGS. 1 and 1a-1f with carbon dioxide comprising part of the regeneration solution. In particular, FIG. 2 includes additional features relative to FIG. 1c. A PFAS-impacted phase (1) feed line (50) is coupled to the contact reactor (9). The contact reactor contains a fluorous functionalized solid support (8). In some embodiments, the contact reactor contains a plurality of adsorbent media. In some embodiments, the contact reactor comprises a packed bed reactor. In some embodiments, the contact reactor comprises a pressure vessel.

As the PFAS-impacted phase (1) passes over the F-media (8) in the contact reactor (9), the PFAS is transferred from the impacted phase to the fluorous phase (4) of the F-media (8) and is removed from the impacted phase, thereby treating the impacted phase. The treated impacted phase is then separated from the F-media (8) in the reactor and discharged via line (51) as a treated phase (7).

To begin a regeneration process of removing PFAS from the contaminated fluorous media, valve (52) on feed line (50) and valve (53) on discharge line (51) are closed to stop the flow of the PFAS-impacted phase (1) into the contact reactor (9). A regeneration solution (11r) is introduced into the contact reactor (9) via feed line (54) coupled to the contact reactor (9). The introduction of the regeneration solution (11r) is controlled by valve (110). The regeneration solution may comprise a polyelectrolyte and an F-solvent as described herein. The regeneration solution may optionally include an organic solvent. The regeneration solution may also be combined with carbon dioxide (11c). The introduction of the carbon dioxide (11c) is controlled by valve (111). The temperature and pressure conditions in the line (54) and the contact reactor (9) may be adjusted to create conditions that put the carbon dioxide in supercritical form. In some embodiments, the regeneration solution may comprise a pH adjustment reagent, e.g., to keep the pH at an acidic level. In some embodiments, the regeneration solution may comprise an organic compound. A heat exchanger (55) may be coupled to the regeneration solution feed line (54) to increase the temperature of the carbon dioxide prior to introduction into the contact reactor (9).

As the regeneration solution passes over the F-media (8), it desorbs (i.e., removes) PFAS from the F-media and transfers it to the regeneration solution (11), thereby producing a PFAS-concentrated regeneration solution phase (5). The PFAS-concentrated regeneration solution phase (5) is then separated from the F-media (8) by discharge via line (56) that is coupled to the contact reactor (9). Part of the PFAS-concentrated regeneration solution phase (5) may be recirculated back to the contact reactor (9) via line (57) to create a more concentrated PFAS phase for greater efficiency in recovery or destruction processes. Alternatively, the PFAS-concentrated regeneration solution phase (5) may be discharged via line (58) for recovery or disposal (6). In embodiments in which supercritical carbon dioxide is included in the regeneration solution, a back-pressure regulator, capillary coils, series of orifice plates, or throttle valves may be in fluid communication with line (58) to depressurize it. When the regeneration cycle is complete, valves (60), (61), and (62) positioned on the regeneration solution lines are closed to stop the sequence.

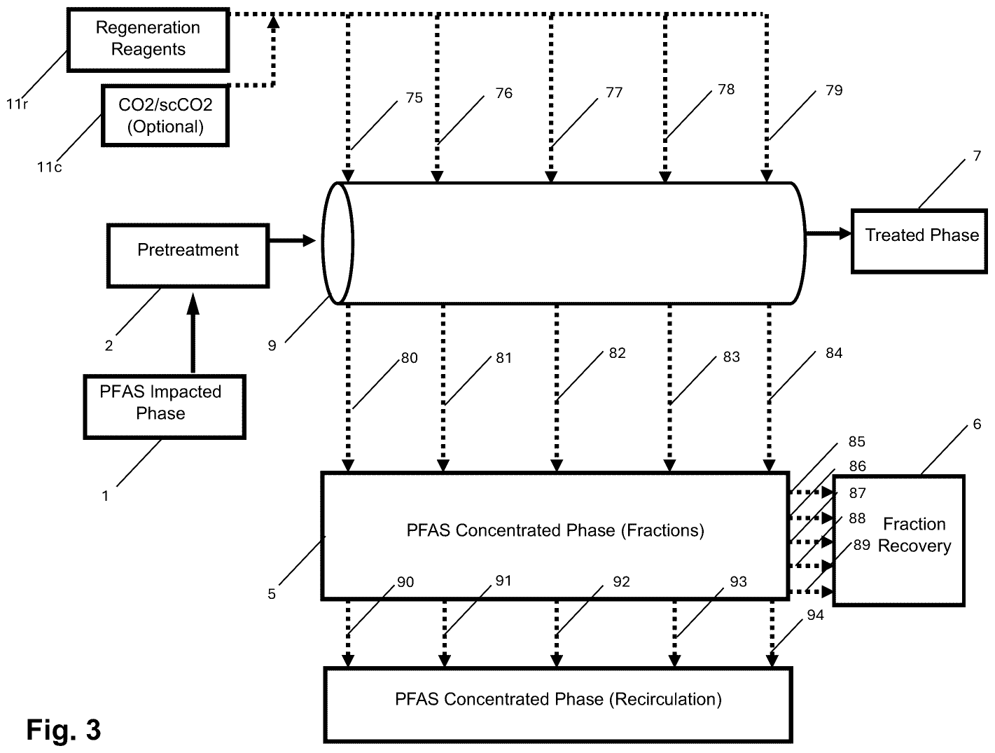

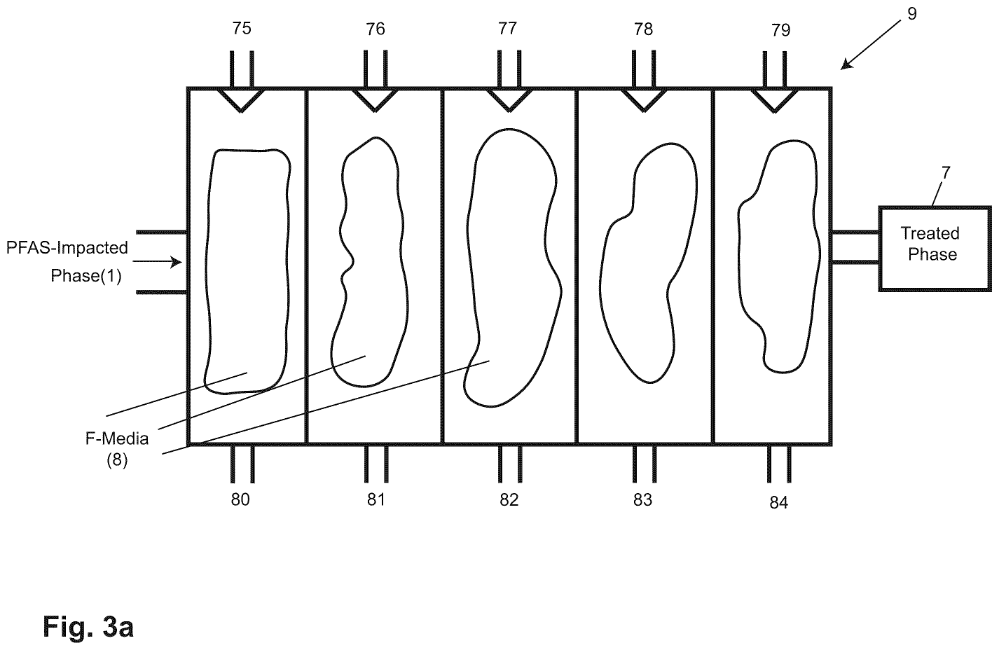

In some embodiments, the contact reactor (9) may comprise a fluorous fractionation reactor. FIG. 3 provides an embodiment of a fluorous fractionation reactor, wherein the PFAS are separated within the contact reactor such that a plurality of PFAS fractions can be recovered during the F-media regeneration process at a plurality of positions along the length of the reactor. FIG. 3 expands upon FIG. 2 for the recovery of a plurality of PFAS fractions due to their separation on the F-media (8) in the contact reactor (9). In some embodiments, the media contained within the fluorous fractionation reactor may comprise a mixture of fluorinated media and non-fluorinated media (e.g. such as activated carbon, etc.). In some embodiments, the fluorous fractionation reactor may comprise a plurality of F-media (e.g., different fluorous functional groups) at a plurality of positions within the reactor to enhance targeted recovery of various PFAS.

As shown in FIG. 3, the regeneration solution (11r) can be added to the contact reactor (9) through a plurality of injection lines (75), (76), (77), (78), and (79) coupled to the reactor (9). The lines (75), (76), (77), (78), and (79) inject the regeneration solution and the regeneration solution extracts the PFAS compounds as it passes over the F-media (8). In a preferred embodiment, the contact reactor (9) has a horizontal orientation, with the injection lines (75), (76), (77), (78), and (79) coupled to the top of the reactor at intervals along the length of the contact reactor (9) for a downflow injection configuration. The concentrated PFAS fractions in the regeneration solution are separated and discharged from the reactor (9) via lines (80), (81), (82), (83), and (84) into a collection vessel, which may be operable to keep the fractions separate. The concentrated PFAS fractions in the regeneration solution can be recovered via lines (85), (86), (87), (88), and (89) or recirculated back to the contact reactor (9) via lines (90), (91), (92), (93), and (94). In some embodiments, the regeneration solution comprises a solvent sweep, wherein the regeneration solution composition changes along the length of the contact reactor at a plurality of injection points.

In some embodiments, an organic solvent is introduced as part of the solvent sweep. The separation of PFAS within the fluorous fractionation reactor can be enhanced by increasing the concentration of organic solvent relative to the aqueous phase due to miscibility preferences. In some embodiments, a pH adjustment reagent may be introduced to maintain the PFAS compounds in an anionic form. In some embodiments, a pH adjustment reagent may be introduced to maintain the PFAS compounds in a nonionic form. The pH adjustment reagent may be introduced as part of the solvent sweep. The pH adjustment reagent may comprise a fluorinated solvent such that it can be recovered within the fluorous fractionation reactor and recirculated (e.g. TFA, etc.). In embodiments in which the regeneration solution comprises a solvent sweep, appropriate reagent injection lines, valves, and other appurtenances may be coupled to the fluorous fractionation reactor to introduce the solvent into the reactor at a plurality of positions.

As shown in FIG. 3A, the reactor may comprise a tubular shell. In some embodiments, the reactor may comprise baffles or other means for separation along its length. In some embodiments, baffles along the length of the reactor may be used to increase the residence time within the reactor along its length and/or within a plurality of segments to enhance separation. The use of baffles can create CSTR zones within the fluorous fractionation reactor, which enhances mixing and contact time with the F-media while enhancing the segregation of various compounds for targeted recovery. In some embodiments, for each CSTR zone, a corresponding regeneration solution chemical injector and ejector may be coupled to the reactor. The tubular shell construction materials can be any suitable material compatible with the chemical reagent(s) and operating conditions. In some embodiments, the tubular shell comprises a pressure vessel. As discussed herein for various embodiments, all injection and ejection lines to and from the fluorous fractionation reactor are coupled with appropriate pressurization, depressurization, heating, and/or cooling devices.

### Section 2. Multiphasic System Embodiment for PFAS-Impacted Aqueous and/or Vapor Phase with Adsorption Pretreatment

This Section 2 discloses embodiments of the present invention using elements, chemical constituents, and processes disclosed in Section 1 associated with the removal, concentration, and/or recovery of PFAS from an PFAS-impacted aqueous and/or vapor.

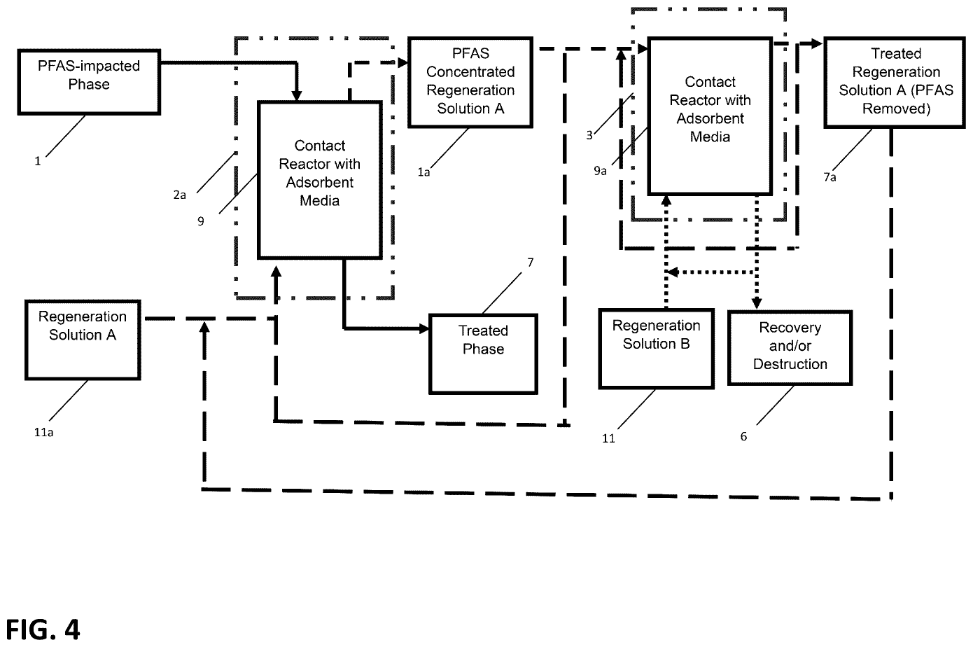

The embodiment disclosed in FIG. 4 adds elements to the embodiments of FIGS. 1b and 1c with a process flow diagram of the adsorption and regeneration process for multiple contact reactors in series that function to further concentrate the PFAS regeneration solution. FIG. 4 illustrates an adsorption pretreatment process (2), the desorption and concentration of PFAS into a regeneration solution (11), the subsequent removal and concentration of PFAS from a regeneration solution with a fluorous system (3), and the subsequent recovery (6) of PFAS with a regeneration solution (11a).

The adsorbent media contained in contact reactors (9) and (9a) may include ion-exchange resin, regenerable ion-exchange resin, activated carbon (powdered and/or granular), functionally modified activated carbon, cyclodextrin, Teflon™, metal oxides, layered double hydroxides, functionally modified layered double hydroxides, hydrogels, carbon dots, zeolites, functionally modified zeolites, functionally modified membranes, polymers, metal organic frameworks, clay based materials, covalent organic frameworks (COFs), chitosan-based media, functionally modified nano-based media, biologically modified media, fungus-based media, zero valent iron, protein and/or protein rich media, polysaccharide-based media, novel sorbents, and combinations thereof that has been functionalized with fluorous moieties. The fluorous functionalized media may be used in contact reactor (9) to selectively remove and concentrate PFAS via the relatively higher adsorption capacity of fluorous functionalized media. In some embodiments, fluorous functionalized media may be used within a contact reactor as a polishing stage for multiple contact reactors in series.

In some embodiments, a pretreatment media regeneration method is disclosed that comprises the use of NSF/ANSI certified chemicals. The regeneration method utilized in contact reactor (9) features the use a pH adjustment reagent, polyelectrolyte, carbon dioxide, pressure, and/heat to facilitate the transfer of PFAS from the adsorbent media in the contact reactor (9a) into the regeneration solution (11). A pH reagent may be added to tune the regeneration solution properties to enhance the desorption of PFAS from the adsorption media. A polyelectrolyte may be added to enhance partitioning between phases (e.g., between solid, supercritical carbon dioxide, carbon dioxide, and aqueous phases) and its properties can be tuned depending on the solution chemistry. Heat and pressure may be applied to transition carbon dioxide to supercritical conditions to enhance miscibility of constituents. Following the transfer of PFAS from the adsorbent media to the regeneration solution (11), the properties of the regeneration solution (11) may be modified such that it becomes an anti-solvent to enhance the removal of PFAS from the regeneration solution for further concentration (e.g., referring to FIG. 4, such as in 9). The regeneration solution has anti-solvent properties through the addition of a pH adjustment reagent, depressurization, and/or cooling. These conditions and constituents facilitate the efficient remove of PFAS from adsorbent media in the contact reactor (9) by the regeneration solution.

The resulting PFAS-concentrated regeneration solution (11a) may be delivered to contact reactor (9a) for removal of PFAS from PFAS-concentrated regeneration solution (11). A fluorous system (3) may be used in contact reactor (9) to selectively remove PFAS from the PFAS-concentrated regeneration solution (11). The fluorous system (3) may comprise a fluorinated solid support to facilitate the selective removal of PFAS from the PFAS-concentrated regeneration solution A (11a) such as that discussed in Section 1. As PFAS is transferred from the PFAS-concentrated regeneration solution (11) to the fluorous system (3), the PFAS-concentrated regeneration solution (11) becomes a treated regeneration solution (7a). In some embodiments, the treated regeneration solution (7a) may be recycled back to contact reactor (9a) for re-use, undergo further treatment, and/or be disposed.

To recover PFAS from the fluorous system (3) in contact reactor (9), regeneration solution (11a) is introduced to transfer PFAS from fluorous system (3) to regeneration solution (11a). Similarly, the regeneration method utilized in contact reactor (9) features the use a pH adjustment reagent, polyelectrolyte, carbon dioxide, pressure, and heat to facilitate the transfer of PFAS from the fluorous system (3) in contact reactor (9) into the regeneration solution (11a). In some embodiments, an organic solvent and/or F-solvent may be used to enhance the transfer of PFAS from the fluorous system (3) to regeneration solution B (11a). A pH reagent may be added to tune the regeneration solution properties to enhance the desorption of PFAS from the media. A polyelectrolyte may be added to enhance partitioning between phases (e.g., between solid, supercritical carbon dioxide, carbon dioxide, organic, fluorous, and aqueous phases) and its properties can be tuned depending on the solution chemistry. In some embodiments, the regeneration process and system for the adsorption media comprises the use of a polyelectrolyte, which may be minimally impacted by pH changes in the regeneration solution. In some embodiments, the use of a cationic polyelectrolyte regeneration solution may enhance the desorption of the anionic form of PFAS from the adsorption media into the regeneration solution through electrostatic interactions.

Heat and pressure may be applied to transition carbon dioxide to supercritical conditions to enhance miscibility of constituents. Following the transfer of PFAS from the fluorous system (3) to regeneration solution (11a), regeneration solution (11a) can be recirculated back to contact reactor (9), undergo further treatment, be recovered for re-use, and/or destroyed (6). Prior further treatment, re-use, and/or destruction, PFAS-concentrated regeneration solution B (11a) may be modified to have anti-solvent properties through the addition of a pH adjustment reagent, depressurization, and/or cooling.

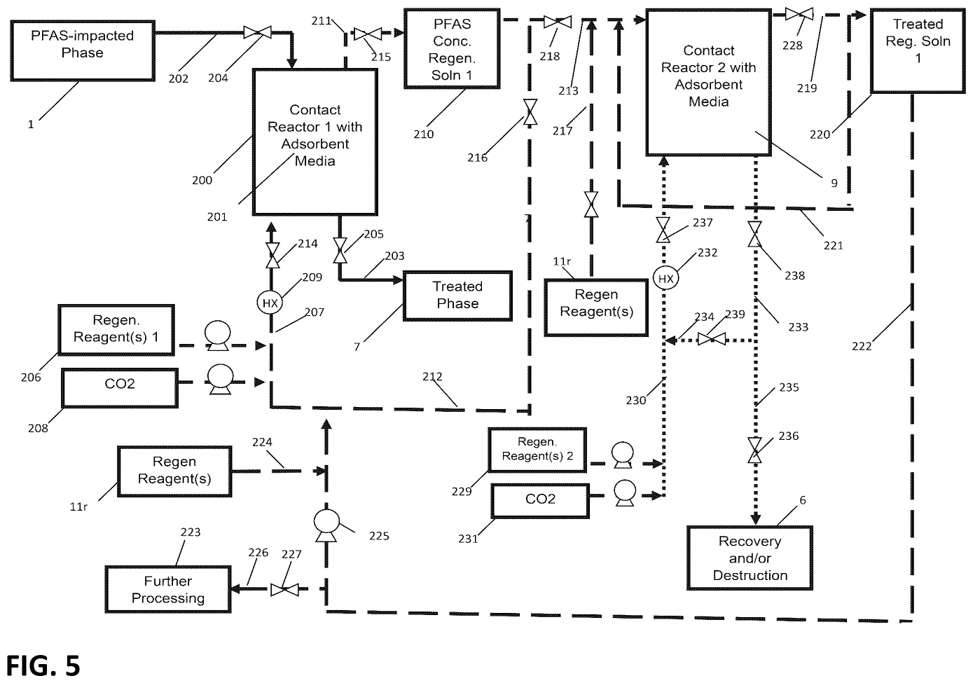

The embodiment of FIG. 5 expands further upon the embodiment of FIG. 4 as a process flow diagram. As shown in FIG. 5, a PFAS-impacted phase (1) is fed through feed line (202) to a primary contact reactor (200) comprising an adsorption media (201). In some embodiments, the feed line (202) is pressurized and supplies the primary contact reactor (200). In preferred embodiments, the primary contact reactor (200) has a downflow configuration, e.g., in which the PFAS-impacted phase (1) flows by gravity to the primary contact reactor (200) through feed line (202). In a preferred embodiment, the primary contact reactor (200) is a packed bed reactor. In other embodiments, the primary contact reactor (200) is a pressure vessel. In other embodiments, the primary contact reactor (200) is column contactor. In some embodiments, the primary contact reactor (200) has a horizontal orientation. In some embodiments, the primary contact reactor (200) has a vertical orientation.

As the PFAS-impacted phase (1) passes over the adsorption media (201) during pretreatment (2), the PFAS from the impacted-phase adsorbs, binds, and/or transfers to the adsorption media (201). As the PFAS is removed from the impacted-phase (1), the impacted-phase becomes a treated phase (7). The treated phase is then separated from the adsorption media (201) and is discharged from the primary contact reactor (200) through a discharge line (203) coupled to the primary contact reactor (200). As the adsorption media (201) adsorbs PFAS and reaches its adsorption capacity, the flow of the PFAS-impacted phase (1) into the primary contact reactor (200) is stopped via valve (204) on feed line (202), the discharge line (203) is closed by valve (205), and a regeneration sequence begins. The valves in discharge line (203), feed line (202), and other lines in the system may be a ball valve, a gate valve, butterfly valve, or other appropriate valve design.

As shown in the embodiment of FIG. 5, regeneration solution (206) (i.e., chemical reagent(s)) are introduced into the primary contact reactor (200) via line (207) coupled to the primary contact reactor (200). In some embodiments, regeneration solution (11r) may further comprise supercritical carbon dioxide (208). In some embodiments, wherein supercritical carbon dioxide mixes with regeneration solution (206), a compressor or pump may be used to pressurize the line (207), such as a gear pump, a diaphragm pump, a peristaltic pump, or other appropriate pump design. In some embodiments, an induced draft (ID) fan and/or a forced draft fan may be used to convey the reagent(s). In some embodiments, carbon dioxide may be pressurized and stored within a tank that may be coupled with flow control and/or depressurization valves that control the pressurized release of the gas such that it mixes with regeneration solution (206, 11r).

Optionally, a heat exchanger (209) may be coupled to the regeneration solution injection line (207). The temperature of the chemical reagent(s) solution may be heated to an elevated temperature. In some embodiments, the temperature of the regeneration solution and/or primary contact reactor is >30 deg C., >50 deg C., >100 deg C., >150 deg C., >200 deg C., or >300 deg C. In some embodiments, the pressure of the regeneration solution and/or primary contact reactor is >800 psi, >1,000 psi, >1,200 psi, >1,400 psi, >1,600 psi, or >2,000 psi.

In some embodiments, regeneration solution (206) reagent(s) may comprise a polyelectrolyte solution. In some embodiments, regeneration solution (206) comprises a cationic polyelectrolyte solution, such as polyDADMAC and/or epiDMA. In some embodiments, the regeneration solution moisture content of the extraction medium is <50 wt %, <25 wt %, <15 wt %, <10 wt %, <5 wt %, or <1 wt %. The chemical reagent(s) solution may further comprise a polyamide.

In some embodiments, the regeneration solution aqueous phase may have a low pH to transfer PFAS from the PFAS-impacted solid phase to the regeneration solution. In some embodiments, the regeneration process and system of the present invention use an alkaline solution to permit advantages that include, but are not limited to, enhancing the resorption of PFAS to the regeneration solution through the reversal of the ionic form of the adsorption media, changing the ionic form of the PFAS compounds, and/or through the participation of SN2 reactions.

In some embodiments, the pH of the regeneration solution is <6, <4, or <2 to remove PFAS from the solid phase. In some embodiments, the regeneration solution comprises citric acid, ferric chloride, ferrous chloride, ferric sulfate, phosphoric acid, polyaluminum chloride, orthophosphate, zinc orthophosphate, polyorthophosphate, blended phosphates, and/or a combination thereof. An acidic regeneration solution may be used to enhance the miscibility of PFAS into the regeneration solution by increasing the quantity of PFAS that are present in their non-ionic form. In some embodiments, a metal salt such as ferric chloride, ferrous chloride, ferric sulfate, polyaluminum chloride, aluminum sulfate, and/or a combination thereof may be used to increase the presence of positively charged constituents such as metal ions to enhance electrostatic interactions between the regeneration solution constituents and PFAS.

In some embodiments, the chemical reagent(s) solution may have an elevated pH to transfer PFAS from the PFAS-impacted solid phase to the regeneration solution. In some embodiments, the pH of the regeneration solution is >8, >9, >10, >11, or >12 to remove PFAS from the solid phase. In some embodiments, the regeneration solution comprises one or more basic agents, such as sodium hydroxide potassium hydroxide, calcium carbonate, sodium carbonate, and/or a combination thereof. A basic regeneration solution may be used to enhance the miscibility of PFAS into the regeneration solution by influencing the strength of cationic chemical constituents present in the regeneration solution (e.g., such as a cationic polyelectrolyte) and/or may weaken the influence of the electrostatic charge of the adsorption media, e.g., by shifting the adsorption media charge from a cationic to a nonionic and/or anionic charge form.

In some embodiments, the use of a plurality of functional groups on and/or within the adsorption media structure may have a cationic form under certain pH conditions, and a neutral form (e.g., weakly basic functional groups) under altered pH conditions. In some embodiments, under neutral pH conditions (pH range from 6-8), a weakly basic functional group may be cationic, which permits the electrostatic interactions between anionic PFAS and the adsorption media which enhances the adsorption of the PFAS to the adsorption media. In some embodiments, with an elevated pH condition (pH>8), a weakly basic functional group on and/or within the adsorption media may be neutralized, which permits a reduction in the affinity of the PFAS compound to the adsorption site. This enhances the desorption process. In some embodiments, the use of an alkaline solution can also enable SN2 reactions between the hydroxides and the electronegative fluorine of the carbon-fluorine bonds. In some embodiments, under certain operating conditions, such as with the application of heat, the PFAS compounds can be defluorinated, which enhances their hydrophilicity and the desorption process into an aqueous regeneration solution. Similarly, in some embodiments, a plurality of reactions may be considered to cleave a plurality of functional groups from the PFAS to influence miscibility.

In some embodiments, a basic regeneration solution may contact the PFAS-impacted solid phase at an elevated temperature and/or pressure such that the PFAS compounds adsorbed to the media undergo a defluorination reaction (i.e., breaking carbon-fluorine bonds), further enhancing the miscibility of PFAS into the regeneration solution. In some embodiments, a basic aqueous solution may contact the PFAS-impacted solid phase prior to the introduction of the regeneration solution at an elevated temperature and/or pressure such that the PFAS compounds adsorbed to the media undergo a defluorination reaction (i.e., breaking carbon-fluorine bonds), further enhancing the miscibility of PFAS into a regeneration solution from reducing the fluorophilicity of the PFAS. In some embodiments, the temperature of the basic solution to enable a defluorination reaction is >100 deg C., >200 deg C., >250 deg C., or >300 deg C. and the pressure is such that the fluid remains in a compressed liquid state.

In some embodiments, carbon dioxide may be used in the chemical reagent(s) solution to enhance the solubility of the PFAS and/or transfer between phases. The chemical reagent solution may include carbon dioxide. The contact reactor (200) comprises equipment for creating conditions to generate supercritical carbon dioxide. The temperature of the regeneration solution (206) and media may be raised to provide conditions for supercritical CO₂ to about >30 deg C. using a heating element, such as a heat exchanger, resistance heater, an immersion heater, steam coils, or other appropriate heating elements. In some embodiments, the temperature of the regeneration solution and/or primary contact reactor is >30 deg C., >50 deg C., >100 deg C., >150 deg C., or >200 deg C. To further provide conditions for supercritical CO₂, the pressure in the contact reactor (200) is increased to >800 psi. In some embodiments, the pressure of the regeneration solution and/or primary contact reactor is >200 psi, >800 psi, >1,000 psi, >1,200 psi, >1,400 psi, >1,600 psi, or >2,000 psi.

As regeneration solution (206) and CO₂ (208) passes over the adsorption media (201), it desorbs (i.e., removes) PFAS from the adsorption media (201) and transfers it to regeneration solution (206), thereby producing a PFAS-concentrated phase (210). The PFAS-concentrated regeneration solution phase (210) is then separated from the adsorption media (201) and discharged via line (211) coupled to the primary contact reactor (200). Part of the PFAS-concentrated regeneration solution 1 phase (210) may be recirculated back to the primary contact reactor (200) via line (212) or may be conveyed via line (213) for further concentration and recovery or disposal (6).

When the regeneration cycle is complete, valves positioned on the regeneration solution lines (214), (215), and (216) are closed to stop the sequence. The regeneration solution may be continuously recirculated over the adsorbent media until the media is treated (e.g. at least part of the PFAS is removed), and then is passed on to further processing. In some embodiments, the adsorbent media may be agitated during the regeneration cycle by an impeller, a turbine, paddle mixtures, a recirculation system, or other mixing device. In some embodiments, carbon dioxide and/or air may be sparged along the length of the contact reactor to agitate the adsorbent media and enhance the transfer of PFAS from the adsorbent media to the regeneration solution. In some embodiments, the temperature and/or pressure of the contact reactor containing the adsorbent media may be increased. In some embodiments, supercritical carbon dioxide may be introduced into the contact reactor during the regeneration cycle at a plurality of locations of the contact reactor.

As shown in the embodiment of FIG. 5, the PFAS-concentrated phase (210) is fed to a secondary contact reactor (9) via line (213) coupled to the secondary contact reactor (9). Prior to being fed to the secondary contact reactor (9), the PFAS-concentrated regeneration solution (210), is converted to an anti-solvent phase. A chemical reagent(s) is injected into line (213) via injection line (217). In addition, line (213) can be depressurized through valve (218), such as a back-pressure regulator to revert supercritical carbon dioxide to carbon dioxide. The PFAS-concentrated regeneration solution (206) is conditioned to anti-solvent phase (210), then is fed to a secondary contact reactor (9) via line (213), wherein the secondary contact reactor contains an F-media such as disclosed herein. As the PFAS-concentrated regeneration solution (206) in anti-solvent phase (210), passes over the F-media (8) in the secondary contact reactor (9), the PFAS is transferred from the PFAS-concentrated phase (210) to the F-media (8) and is removed from the impacted phase, thereby treating the impacted phase. The impacted phase/treated phase is then separated from the F-media (8) and discharged via line (219) coupled to the secondary contact reactor (9) as a treated regeneration solution phase (220). The treated regeneration solution phase (220) may be recirculated back to the secondary contact reactor (9) via recirculation line (221) and/or recirculated back to the primary contact reactor (200) via recirculation line (222) and/or conveyed to further processing (223). The means to pressurize and reactivate regeneration solution (220) are provided on recirculation line (222) through a reagent injection line (224) and pump or compressor (225). Prior to further processing (223) of treated regeneration solution (220), the discharge line (226) may be further depressurized by, e.g., a back-pressure regulator (227).

Similar to the embodiments discussed in Section 1, as the media adsorbs PFAS and reaches its adsorption capacity, a regeneration sequence begins in the secondary contact reactor (9) by stopping the flow of the PFAS-concentrated phase (210) into the secondary contact reactor (9) via valve (218) and the discharge line valve (228).

Regeneration solution 2 (229) is introduced into the secondary contact reactor (9) via line (230) coupled to the secondary contact reactor (9). In some embodiments, the regeneration solution may comprise a polyelectrolyte solution. In some embodiments, the regeneration solution may further comprise supercritical carbon dioxide (231). In some embodiments regeneration solution (229) comprises a fluorinated solvent. In some embodiments regeneration solution (229) comprises a pH adjustment reagent. In some embodiments regeneration solution (229) comprises a fluorinated solvent that is acidic that decreases the pH to <6. In other embodiments regeneration solution (229) comprises a fluorinated solvent that is basic that increases the pH>9.

In some embodiments, the regeneration solution may comprise an organic compound. In some embodiments, wherein supercritical carbon dioxide mixes with the regeneration solution. Optionally, a heat exchanger (232) may be coupled to the injection line (230) to heat the regeneration solution (229). Line (230) may also be pressurized by a compressor or pump as disclosed herein.

As the regeneration solution passes over the F-media (8), it desorbs (i.e., removes) PFAS from the F-media and transfers it to the regeneration solution (229), thereby producing a PFAS-concentrated phase (5). The PFAS-concentrated regeneration solution phase (5) is then separated (10) from the F-media (8) and discharged via line (233). Part of the PFAS-concentrated regeneration solution phase (5) may be recirculated back to the contact reactor (8) via line (234) or may be discharged via line (235) for recovery or disposal (6). In some embodiments, the regeneration solution include supercritical carbon dioxide further comprises. Line (230) may also be depressurized by a valve (236) positioned on line (233) . . . . When the regeneration cycle is complete, valves positioned on the regeneration solution lines (237), (238), and (239) are closed to stop the sequence.

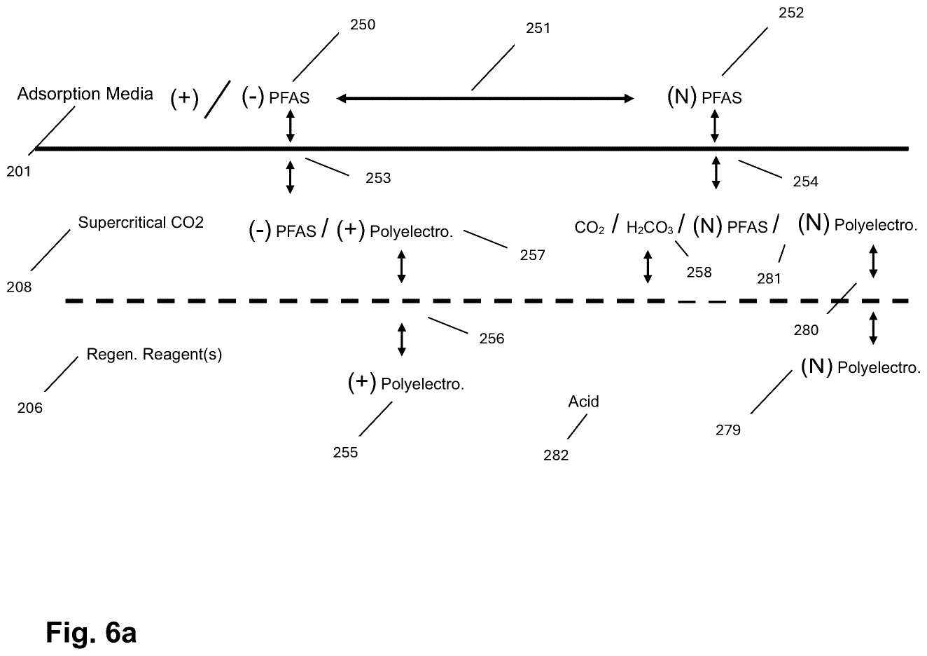

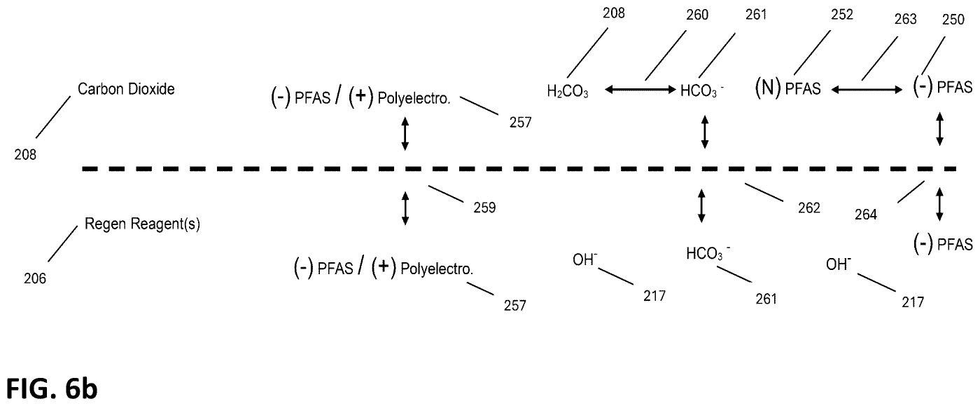

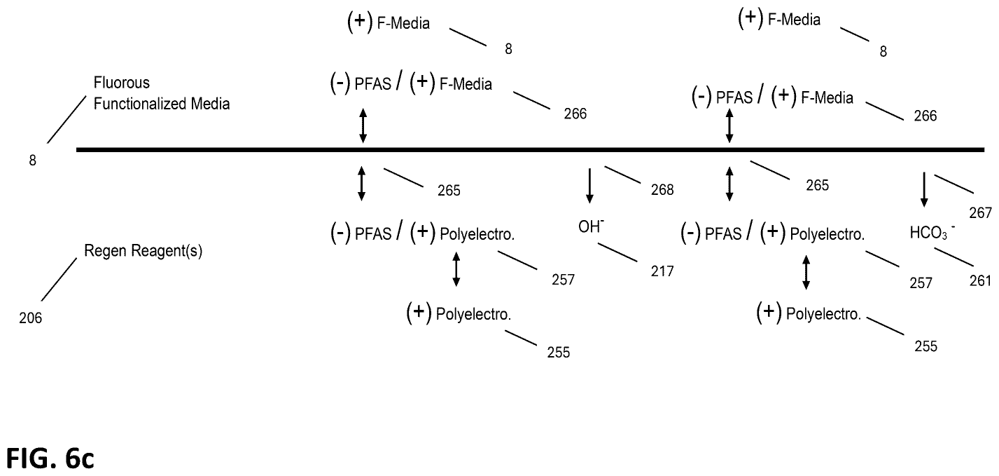

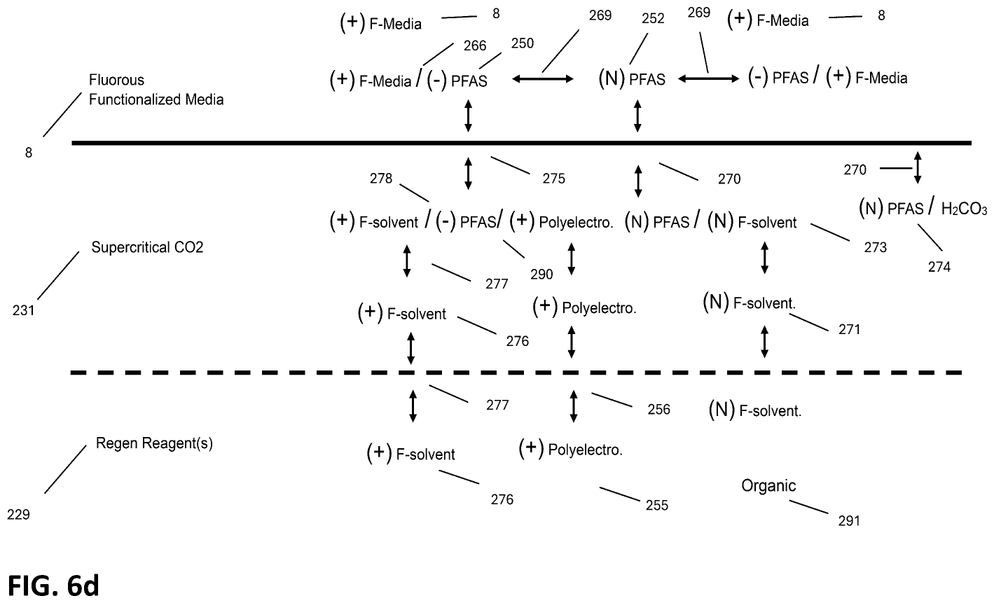

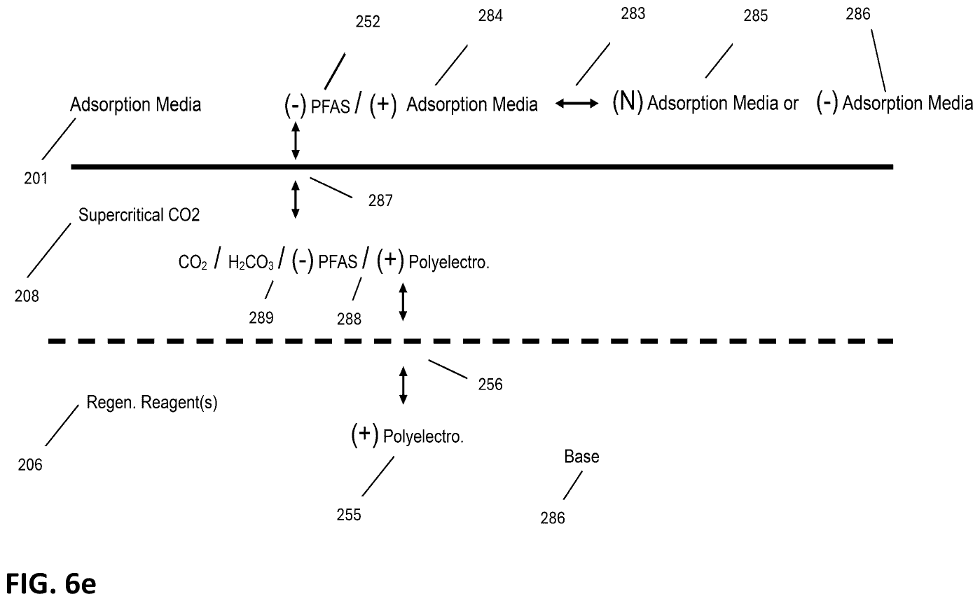

FIG. 6a shows the PFAS desorption scheme, which includes the adsorption media (201), regeneration solution (206), and additional constituents to transition the PFAS to transition (251) from their anionic form (250) to their neutral form (252). The additional constituents may include an acidic agent (282) and/or supercritical carbon dioxide (208). In some embodiments, the adsorption media (201) may comprise a cationic form and with the change (251) to the neutral PFAS form (252), the attraction to the cationic adsorption media (201) is weakened during the desorption process and drives the desorption of PFAS from the adsorption media (201) as shown by dissolutions (253) and (254) into the supercritical CO₂. Furthermore, due to the acid/base interactions with supercritical carbon dioxide and the electronegative nature of the carbon-fluorine bonds of PFAS, the neutral form of PFAS (252) will tend to desorb due to its affinity towards the stability with H₂CO₃ as shown by (258). The use of a cationic polyelectrolyte (255) will tend to transfer (256) into the supercritical carbon dioxide phase (208), which will tend to form a stable pair with the residual anionic forms of PFAS in solution such as shown by (257). In some embodiments, a nonionic polyelectrolyte (279) may be used that will tend to transfer (280) to the supercritical carbon dioxide phase and form a pair with nonionic forms of PFAS (281).

After the PFAS-concentrated regeneration solution (206) phase (210) is separated from the adsorption media (201), the regeneration solution (206) phase is transitioned to an anti-solvent phase with the addition of a chemical reagent(s). As shown in the anti-solvent scheme provided in FIG. 6b, an alkaline amendment (217) is added to the PFAS concentrated regeneration solution phase (206) to convert it to an anti-solvent. In a preferred embodiment, the chemical reagent(s) solution comprises an aqueous solution with sodium hydroxide or potassium hydroxide. After the pH adjustment and/or a depressurization, the neutral PFAS (252) will tend to revert back (263) to their anionic form (250) and H₂CO₃ (208) will tend to revert (260) to its bicarbonate form (261), which these forms will tend to transition (262)/(264) to the aqueous polyelectrolyte phase (206). The anionic forms of PFAS (250) that formed a stable pair with the cationic polyelectrolyte (257) will also tend to transition (259) to the aqueous polyelectrolyte phase (206). The anti-solvent may comprise a reduced pH such that the PFAS transition from an anionic form to a neutralized form, such that the fluorine-fluorine interactions would dominate, enhancing the partitioning and adsorption of the PFAS compounds from the regeneration solution to the adsorption media. In some embodiments, even if a cationic polyelectrolyte is present in the regeneration solution, the neutral form of PFAS has less of an affinity to the cationic polyelectrolyte within the regeneration solution, compared to the fluorous functional groups of the adsorption media. In some embodiments, the cationic polyelectrolyte would pass over the fluorous functionalized media so the regeneration solution can be recovered and reused.

The adsorption of PFAS from the anti-solvent phase to the F-media is illustrated in the scheme provided in FIG. 6c. The F-media (8) may comprise a cationic and/or neutral form in the presence of the anti-solvent phase. The presence of the anionic bicarbonate and/or carbonate (261) and hydroxide (217) in the aqueous phase will tend to drive the adsorption of PFAS from the aqueous phase to the F-media (265) in addition to the PFAS affinity for the fluorous functional groups. The bicarbonate/carbonate and hydroxide tend to be repulsed from the fluorous/fluorous interactions and are driven away from the F-media as shown by (267) (268). Even though the cationic polyelectrolyte and anionic PFAS may form a stable pair (257) in aqueous solution, the PFAS tend to preferentially partition/bind to the F-media due to the strong fluorous-fluorous interactions in combination with the electrostatic interactions, driving PFAS adsorption to the F-media (265) (266).

The subsequent desorption of PFAS from the F-media is illustrated in the scheme provided in FIG. 6d. The regeneration solution (229) may comprise an F-solvent (271) (276) and supercritical carbon dioxide (231). In the presence of regeneration solution (229), the anionic PFAS (250) may tend to transition (269) to neutral forms (252) due to the presence of the acidic solution. In a preferred embodiment, the F-solvent (229) comprises a cationic F-solvent (276) and neutral F-solvent (271). In some embodiments, regeneration solution (229) may further comprise one or more polyelectrolytes (255) (e.g. cationic polyelectrolyte).

The one or more polyelectrolytes (255) may transfer (256) to the supercritical carbon dioxide phase (231) and may tend to form a stable pair with residual anionic PFAS (290). In some embodiments, regeneration solution (229) may further comprise an organic solvent that functions as a miscible carrier phase. Due to the fluorophilicity of scCO₂ (231), the F-solvents (271) (276) tend to be soluble in the scCO₂ phase and partition as shown by (272) (277). The presence of the F-solvents in the scCO₂ phase tend to form stable pairs with both the neutral and anionic forms of PFAS as shown by (273) (278). Similar as described for FIG. 6a, the neutral form of PFAS (252) will tend to desorb (270) due to its affinity towards the stability with H₂CO₃ (231) as shown by (274). In an alternative embodiment, the F-media may tend to transition to a neutral and/or anionic form in the presence of a pH controlled scCO₂ and fluorous phase, further weakening the affinity of the neutral PFAS (250) and/or anionic PFAS (252) to the F-media (8) compared to regeneration solution (229).

FIG. 6e presents desorption scheme utilizing an alternative liquid adsorption media (201). The adsorption media may tend to transition (283) from a cationic form (284) to a neutral (285) and/or anionic form (286) due to the use of an basic agent (286) and supercritical carbon dioxide (208). The PFAS affinity to the adsorption media (201) is weakened during the desorption process when the adsorption media (201) transitions to a neutral form (285) or anionic form (286), and thereby drives the desorption of anionic PFAS from the adsorption media (201) as shown by transition arrow (287). The use of a cationic polyelectrolyte (255) will tend to transfer (256) to the supercritical carbon dioxide phase (208), which will tend to form a stable pair (288) with the anionic forms of PFAS (252) in solution. The use of a nonionic polyelectrolyte may be used to enhance the phase transfer of an ionic polyelectrolyte. Furthermore, due to the acid/base interactions with supercritical carbon dioxide and the electronegative nature of the carbon-fluorine bonds of PFAS, the anionic form of PFAS (252) may tend to desorb due to its affinity towards with a stable combination (289) with CO₂/H₂CO₃. It is to be appreciated that the chemicals used for the regeneration solution extraction and anti-solvent properties may be dependent on the matrix chemistry and treatment goals (e.g., targeted recovery, etc.).

In some embodiments, the pH of the PFAS concentrated regeneration solution is adjusted prior to and/or within contact reactor. In a preferred embodiment, the pH of PFAS concentrated regeneration solution is decreased to <6. The pH of the PFAS concentrated regeneration solution 1 may be decreased to <6 prior to contact reactor 2 using citric acid. The PFAS concentrated regeneration solution passes through the adsorption media in contact reactor 2, there is a “pH sweep” such that there is a gradual change in pH that occurs with multiple injection points in the contact reactor.

The adsorbent media may be similar or different between contact reactors in a PFAS recapture system according to the present invention. In a preferred embodiment, the adsorbent media in a first contact reactor and/or a second contact reactor include a solid media as disclosed herein (e.g., fluorinated silica) with a cationic charge and fluorous functional groups (i.e., fluorous moieties). In a some embodiments, a first contact reactor comprises adsorbent media with fluorous functional groups and a cationic charge and a second contact reactor may comprise adsorbent media with a plurality of fluorous functional groups such that they have a plurality of charges such as cationic, anionic, and/or neutral charges. In some embodiments, the adsorbent media comprise fluorous functional groups that enable the reversal of the cationic and/or anionic charges. The adsorbent media may comprise functional groups that are weakly basic such that the charge can be reversed through the regeneration process.

For example, a PFAS-impacted drinking water matrix is introduced into the contact reactor containing an adsorbent media through an inlet. The PFAS-impacted drinking water matrix may be pretreated prior to the contact reactor. The PFAS-impacted drinking water matrix passes/flows over the adsorbent media and the PFAS from the impacted drinking water matrix partitions and/or adsorbs and/or binds to the adsorbent/sorbent media. The PFAS-impacted matrix becomes treated as the PFAS is removed from the matrix. The treated matrix then passes through an outlet of the contact reactor. After the adsorbent media has been in contact with a supply of a PFAS-impacted drinking water matrix and has reached its adsorption capacity, a regeneration cycle begins.

Embodiment of the regeneration cycle/sequence involve stopping the flow of the PFAS-impacted drinking water matrix into the contact reactor and then introducing chemical reagent(s)/reactant(s) (i.e., regeneration solution) into the contact reactor through an inlet. The regeneration solution passes/flows over the adsorbent media that is contaminated with PFAS, and the PFAS desorb and/or transfer from the adsorbent media to the regeneration solution. The regeneration solution becomes concentrated with PFAS and then passes through an outlet of the contact reactor. The regeneration solution can be discharged from the contact reactor for further treatment/processing and/or continuously recirculated over the adsorbent media.

As shown in FIG. 4, in some embodiments, the PFAS concentrated regeneration solution from contact reactor (9) (i.e. PFAS concentrated regeneration solution (11)) may then be passed through contact reactor (9a) to further concentrate the regeneration solution for further processing. PFAS concentrated regeneration solution (11) may be pretreated prior to contact reactor (9a). The PFAS concentrated regeneration solution (11) passes/flows over the adsorbent media in contact reactor (9) and the PFAS from the PFAS concentrated regeneration solution (11) partitions and/or adsorbs and/or binds to the adsorbent/sorbent media. The PFAS concentrated regeneration solution 1 becomes treated as the PFAS is removed from the regeneration solution. The treated regeneration solution (11) then passes through an outlet of contact reactor (9a) and can be recirculated back into contact reactor (9a) and/or recirculated back to contact reactor (9) for re-use. After the adsorbent media in contact reactor (9a) has been in contact with a supply of a PFAS concentrated regeneration solution (11) and has reached its adsorption capacity, the regeneration cycle for contact reactor (9a) begins.

The regeneration cycle/sequence involves stopping the flow of the PFAS concentrated regeneration solution (11) into contact reactor (9a) and then introducing chemical reagent(s)/reactant(s) (i.e., regeneration solution (11a)) into contact reactor (9a) through an inlet. Regeneration solution (11a) passes/flows over the adsorbent media that is contaminated with PFAS in contact reactor (9a), and the PFAS desorb and/or transfer from the adsorbent media to regeneration solution (11a). Regeneration solution (11a) becomes concentrated with PFAS and then passes through an outlet of contact reactor (9a). Regeneration solution (11a) can be discharged from contact reactor (9a) for further treatment/processing and/or continuously recirculated over the adsorbent media in contact reactor (9a). In a slightly preferred embodiment, regeneration solution (11a) is continuously recirculated over the adsorbent media until the media is treated (e.g. at least part of the PFAS is removed), and then is passed on to further processing. In a preferred embodiment, the further processing for regeneration solution (11a) comprises a PFAS destruction and/or mineralization treatment process.

### Section 3. Multiphasic System Embodiment for PFAS-Impacted Aqueous and/or Vapor Phase with Foam Fractionation Pretreatment

This Section 3 discloses embodiments of the present invention for the removal, concentration, and/or recovery of PFAS from a PFAS-impacted phase using foam fractionation as pretreatment and the subsequent concentration and recovery of PFAS using a packed bed reactor with fluorinated media.

Foam fractionation is a treatment process that removes PFAS from impacted aqueous matrices by taking advantage of the affinity that PFAS has to partition to air/water interfaces. Foam fractionation sparges air through aqueous matrices impacted by PFAS producing bubbles for the PFAS to partition to due to their hydrophobic and hydrophilic nature. The PFAS compounds partition to the air/water interfaces of the bubbles and they rise to the top with the bubbles where they are removed from the aqueous matrix surface. This treatment approach has gained attention because in addition to using air, it is not affected by the presence of salts, organics, or other co-contaminant species. In general, it is also inexpensive to operate because it uses air and typical sparging/vacuum equipment and can take a large volume of PFAS impacted water/wastewater concentrating down to very low volumes which improves treatment costs. It also is capable of high removal rates of PFAS compounds that have long carbon chains (>6-8 carbon compounds). Because the primary PFAS compounds that have gained attention include PFOA and PFOS are 8 carbon chain compounds, they are easily removed from foam fractionation processes down to very low discharge levels. However, foam fractionation has limited efficacy with respect to removing short chain and ultra short chain species. This includes PFAS compounds such as PFBA, PFBS, etc. Some of these compounds have been proposed under the state and federal Maximum Contaminant Level (MCL) with very low limits (down to low part per trillion (ppt) levels) and foam fractionation systems are challenged with meeting this limit.

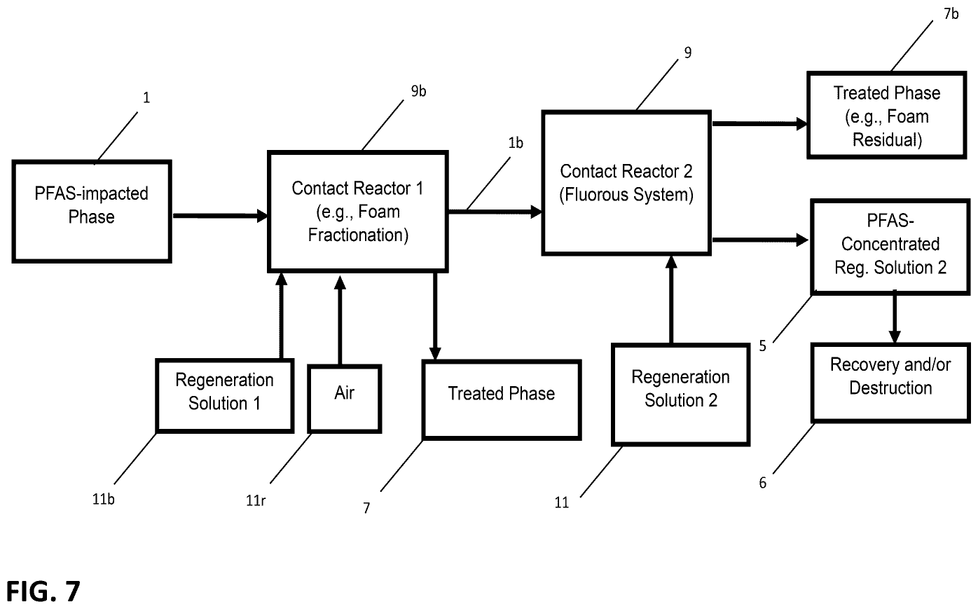

FIG. 7 expands upon the embodiment of FIG. 1a with a process flow diagram of a foam fractionation pretreatment process and the subsequent concentration and recovery of PFAS with a fluorous system. FIG. 7 illustrates a foam fractionation pretreatment process (20) with supplemental regeneration solution reagent(s) (11), the subsequent removal and concentration of PFAS from the foam fractionate residual (1b) with a fluorous system (9), and the subsequent recovery (6) of PFAS with a regeneration solution (11a) from the fluorous system. In some embodiments, the air (11r) that is introduced into the foam fractionation pretreatment process has an elevated carbon dioxide concentration. In some embodiments, the air (11r) that is introduced into the foam fractionation pretreatment process has a carbon dioxide concentration >0.02 wt %, >0.04 wt %, >0.8 wt %, >1.6 wt %, >2.5 wt %, >5 wt %, or >10 wt %.

The residence time in the foam fractionation contact reactor is such that it is adequate for at least partial PFAS removal from the impacted matrices. The concentrated foam fractionate may be conveyed to a recovery process and/or to a PFAS destruction/mineralization process for disposal. The treated aqueous phase (PFAS removed) is pumped from the bottom of the vessel into an equalization tank for further treatment or discharge, depending on targeted contamination levels. In some embodiments, the regeneration solution (11b) comprises a pH adjustment reagent to decrease the pH to <8, <6, or <4.

In some embodiments, the regeneration solution comprises a polyelectrolyte. In some embodiments, the PFAS-impacted matrices are combined with a cationic surfactant (11b) prior to and/or within an aeration vessel such that bubbles are enhanced within the vessel, and the PFAS compounds rise to the top.

In other embodiments, the PFAS-impacted matrices are combined with a fluorous surfactant additive (11b) prior to or within an aeration vessel/tank (90) such that bubbles are enhanced within the vessel, and the PFAS compounds rise to the top and can be removed from the vessel (90) into a highly concentrated foam fractionate. The selected fluorinated surfactant additive will depend on the PFAS contaminated matrices, any potential treatment upstream, any potential downstream treatment processes, and the treatment goals for the PFAS-impacted matrices. In some embodiments, Foam fractionation vessels may occur in parallel or series depending on the system treatment goals.

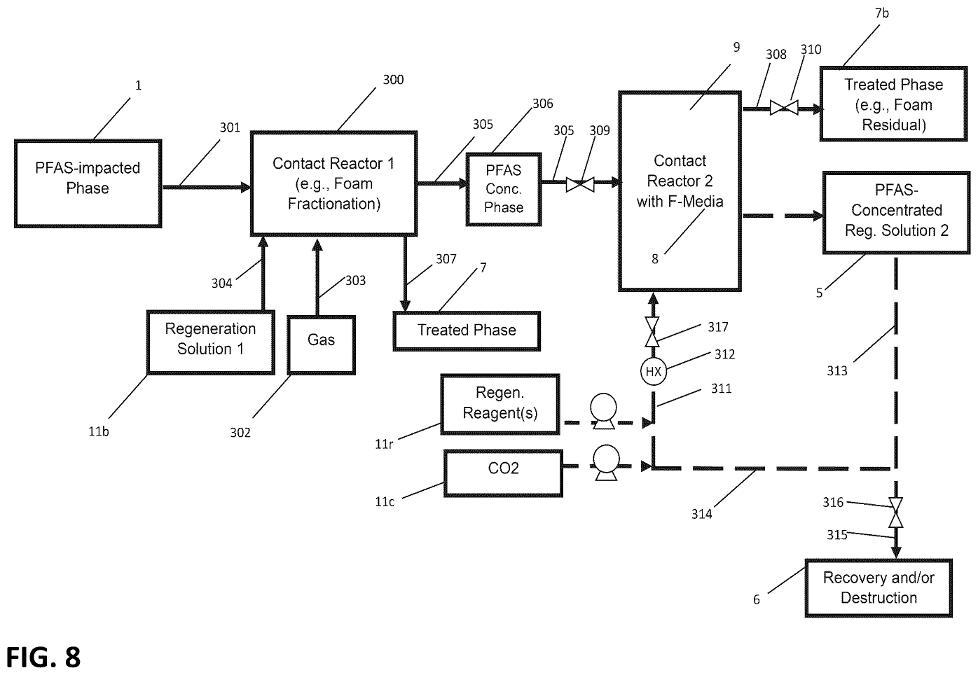

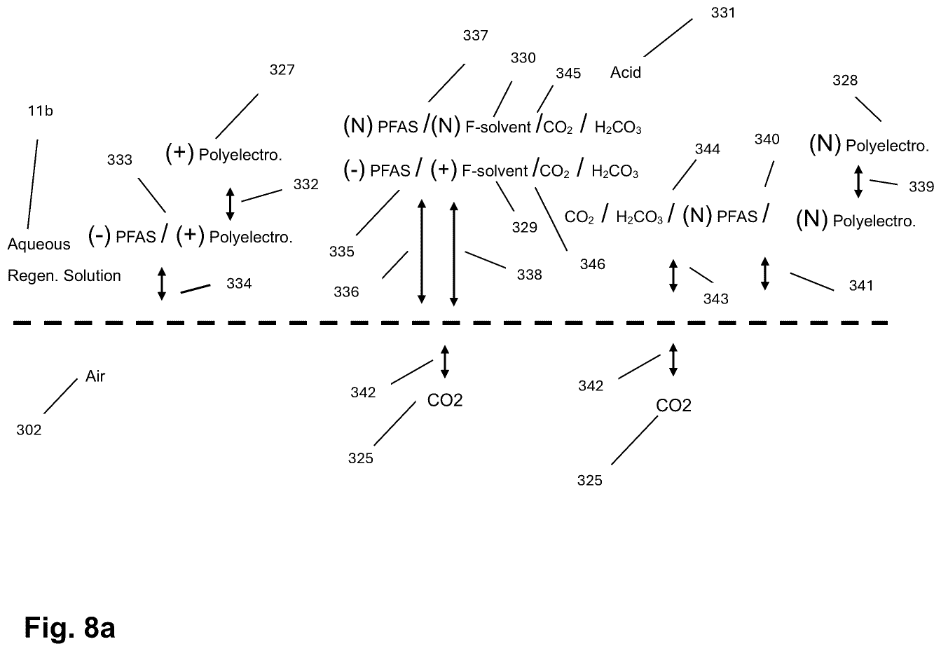

FIG. 8 expands upon the embodiment of FIG. 7 as a process flow diagram. As shown in the embodiment of FIG. 8, a PFAS-impacted phase (1) is fed to a primary contact reactor (300) through feed line (301). A pressurized gas/vapor supply (302) is fed to the primary contact reactor (300) through feed line (303). A compressed gas source or a gas source in fluid communication with a compressor or pump (302) may be used to inject and/or sparge the gas/vapor is provided at the base of the primary contact reactor (300). As the vapor bubbles are introduced into the primary contact reactor (300), a foam is produced and the PFAS partition to the foam/vapor phase. The foam rises to the top of the primary contact reactor (300). In some embodiments, regeneration solution (11) is injected through injection line (304) to enhance partitioning of PFAS and/or foam characteristics. In some embodiments, an F-solvent and/or surfactant is injected into the primary contact reactor (300) through injection line (304) to enhance partitioning and/or foam physical characteristics. In some embodiments, a fluorinated cationic surfactant may be added. The basis for the additive is a fluorinated cationic surfactant as it takes advantage of the affinity that PFAS compounds have towards fluorous compounds and their electrostatic interactions with cationic surfactants. In some embodiments, regeneration solution (11) comprises carbon dioxide. At the top of the primary contact reactor (300), the foam is collected, separated, and conveyed through discharge line (305) coupled to the primary contact reactor (300). The PFAS is concentrated in the foam, thereby producing a PFAS-concentrated foam fractionate (306). In some embodiments, the foam is collected and separated (10) via a vacuum-based separation method and/or device (not shown). The PFAS-impacted aqueous phase becomes treated as the PFAS is removed and is discharged via line (307) coupled to the primary contact reactor (300). In a preferred embodiment, the primary contact reactor (300) has a vertical orientation. In a preferred embodiment, the primary contact reactor (300) has an upflow configuration, wherein the foam and concentrated PFAS rise to the top of the reactor. In some embodiments, the primary contact reactor (300) comprises a stripping reactor and/or column.

Similar to the description in Section 1, the PFAS-concentrated foam fractionate (306) produced from pretreatment is introduced into a fluorous system comprising a contact reactor (9) containing an F-media (8). As the PFAS-concentrated foam fractionate (306) passes over the F-media (8) in the contact reactor (9), the PFAS is transferred from the impacted phase to the fluorous phase of the F-media (8) and is removed from the impacted phase, thereby treating the impacted foam fractionate phase. The impacted phase/treated phase is then separated from the F-media (8) and discharged via line (308) as a treated phase (7b). As the F-media adsorbs PFAS and reaches its adsorption capacity, the flow of the PFAS-concentrated foam fractionate phase (306) into the contact reactor (9) is stopped via valve (309) on feed line (305) and the discharge line valve (310) is closed, and a regeneration sequence begins.

The regeneration sequence of these embodiments follows that described in Section 1. A regeneration solution (11a) is introduced into the contact reactor (9) via line (311) coupled to the contact reactor (9). In some embodiments, the regeneration solution may comprise an F-solvent. In some embodiments, the regeneration solution may comprise an organic compound. In some embodiments, the regeneration solution may comprise a polyelectrolyte solution. In some embodiments, the regeneration solution may further comprise supercritical carbon dioxide (11c). In such embodiments, a pressurized CO₂ source or a CO₂ source in fluid communication with a compressor or pumpmay provide pressurized CO₂ through the line (311) to contact reactor (9). Optionally, a heat exchanger (312) may be coupled to the regeneration solution injection line (311).

As the regeneration solution passes over the F-media (8), it desorbs (i.e., removes) PFAS from the F-media and transfers it to the regeneration solution (11), thereby producing a PFAS-concentrated phase (5). The PFAS-concentrated regeneration solution phase (5) is then separated from the F-media (8) and discharged via line (313). Part of the PFAS-concentrated regeneration solution phase (5) may be recirculated back to the contact reactor (9) via line (314) or may be discharged via line (315) for recovery or disposal (6). In embodiments that utilize supercritical carbon dioxide, line (315) may be depressurized using a back-pressure regulator (316) or other appropriate device. When the regeneration cycle is complete, valves positioned on the regeneration solution lines (311) is closed to stop the sequence.

FIG. 8a shows a version of PFAS recovery reactions using regeneration solution (11b) with an elevated concentration of CO₂ (325) in the air (302) injected into the contact reactor, a cationic polyelectrolyte (327) and nonionic polyelectrolyte (328), and cationic (329) and nonionic (330) fluorinated solvents, and acidic agent (331) that is introduced into the contact reactor (300). The cationic polyelectrolyte (327) will tend to form stable pairs (333) with the anionic forms of PFAS and partition at the air/water interface (334). The cationic F-solvent (329) will tend to form stable pairs (335) with the anionic forms of PFAS and partition at the air/water interface (336). Conversely, the nonionic F-solvent (330) will tend to form stable pairs (337) with nonionic forms of PFAS and partition at the air/water interface (338). The nonionic polyelectrolyte (328) will form stable pairs (340) with the nonionic PFAS as show by and partition at the air/water interface (341).

Similar to FIG. 6a, the carbon dioxide may partition at the air/water interface (342) and dissociate (343) into water to form carbonate species and stable pairs with PFAS, including PFAS-carbonic acid (344), PFAS-bicarbonate (345), and PFAS-carbonate (346) facilitating the partitioning of PFAS to the air/water interface (349). In some embodiments, cationic organic surfactant (347) (e.g., CTAB, etc.) may be introduced into contact reactor (300), and may form stable pairs (348) with anionic forms of PFAS, which then tend to partition at the air/water interface (349). In some embodiments, the scheme for transitioning the regeneration solution (11b) to an anti-solvent can follow that discussed for FIG. 6b, the adsorption of PFAS to F-media can follow that discussed for FIG. 6c, and the desorption of PFAS from the F-media can follow that discussed for FIG. 6d.

### Section 4. Multiphasic System Embodiment for PFAS-Impacted Aqueous and/or Solid Phase with L/L Extraction Pretreatment

This Section 4 discloses embodiments of the present invention for the removal, concentration, and/or recovery of PFAS from a PFAS-impacted phase using liquid/liquid extraction (LLE) as pretreatment and the subsequent concentration and recovery of PFAS using a contact reactor (e.g., packed bed reactor) with fluorinated media.

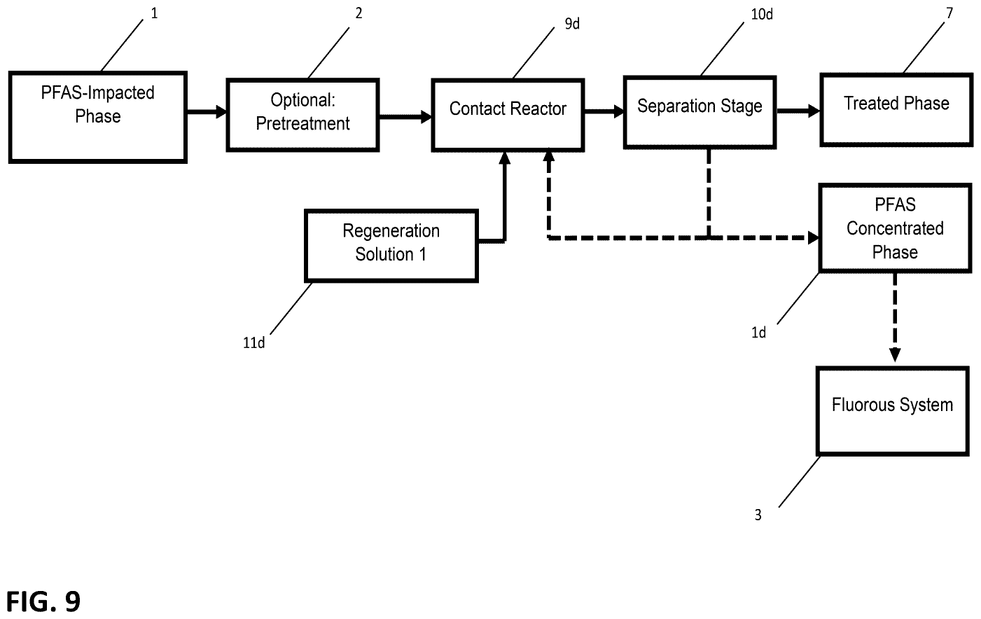

The embodiment of FIG. 9 expands upon the embodiment of FIG. 1a with a process flow diagram of an LLE pretreatment process (25) and the subsequent concentration of PFAS with a fluorous system. FIG. 9 illustrates a PFAS-contaminated matrices (1), which may be for example an industrial wastewater, that may be pretreated prior to entering a reaction tank (9) or continuously stirred tank reactor (CSTR) with the regeneration solution (11). PROVIDE EXPLANATION OF LLE

The PFAS-contaminated matrices and the regeneration solution are mixed for an appropriate residence time that results in at least partial mobilization of the PFAS compounds to the regeneration solution phase (11). Following adequate time, the mixture enters a separation stage (10), which may be a sedimentation tank or a centrifuge. After adequate time for separation, the treated aqueous phase (7) is decanted/drawn from the top of the tank and discharged for further processing and/or discharge. In some embodiments, the PFAS concentrated phase (5) is then recirculated back to the CSTR for reuse and a portion of it is sent to a downstream destruction treatment process.

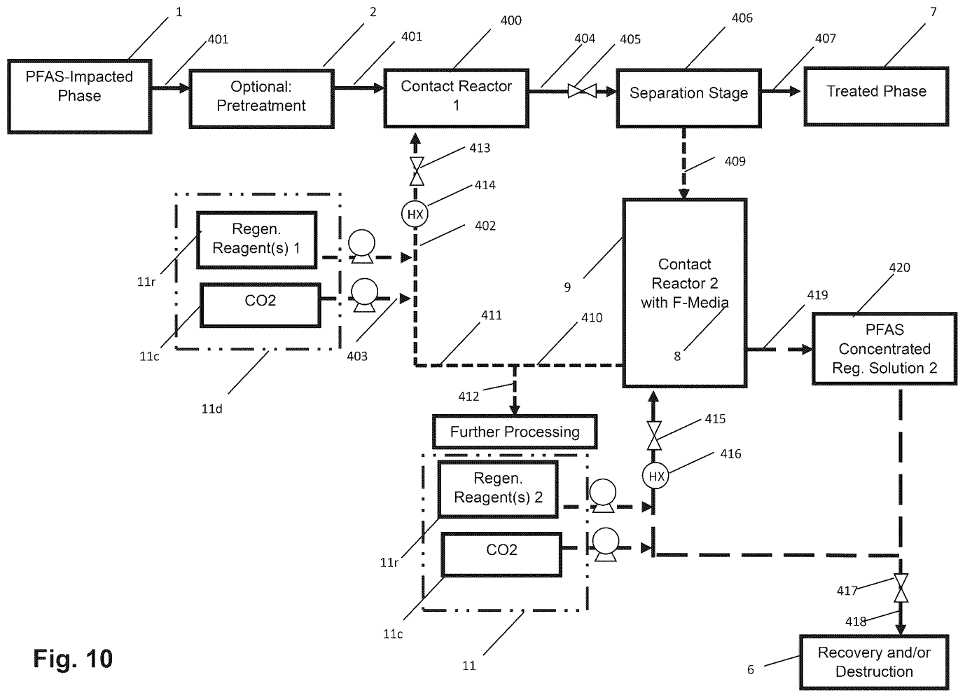

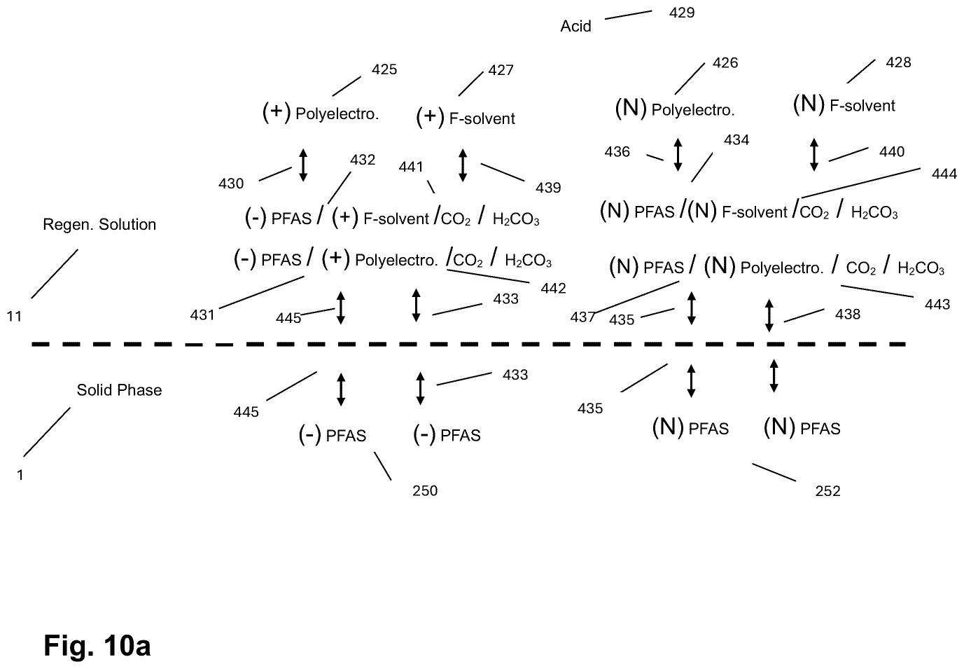

The embodiment of FIG. 10 expands upon the embodiment of FIG. 9 as a process flow diagram for an LLE and fluorous system in series. As shown in FIG. 10, a PFAS-impacted phase (1) is fed to a primary contact reactor (400) through feed line (401). In some embodiments, the PFAS-impacted phase (1) may be pretreated prior to being fed to primary contact reactor (400) through known in an LLE process as disclosed herein. In some embodiments, the pretreatment may comprise a liquid/solid extraction. In some embodiments, the primary contact reactor (400) may be a CSTR. In some embodiments, the primary contact reactor (400) is a pressure vessel. A regeneration solution (11) may be provided into the primary contact reactor (400) through injection line (402). The regeneration solution comprises a fluorous solvent. In some embodiments, the regeneration solution may also comprise an organic solvent. In some embodiments, the regeneration solution may also comprise a polyelectrolyte. Carbon dioxide may be added into the contact reactor (400). In some embodiments, a supercritical carbon dioxide injection line (403) is coupled to the primary contact reactor (400) or injection line (402). The PFAS-impacted phase (1) and regeneration solution (11) are mixed in the primary contact reactor (400) for an appropriate residence time that results in at least partial partitioning of the PFAS compounds to the regeneration solution phase (11). After a given residence time, the mixture is discharged from an outlet of the primary contact reactor (400) via discharge line (404), the mixture may be depressurized through a back-pressure regulator (405), and then conveyed to a coupled separator (406) downstream. The separator (406) has an outlet for each of the phases, wherein the treated impacted phase (7) from which PFAS is removed is separated via a discharge line (407) and the PFAS-concentrated phase (408) is conveyed via discharged line (409) to a contact reactor (9) containing F-media (8).

Similar to the description in Section 1, as the PFAS-concentrated phase (408) passes over the F-media (8) in the contact reactor (9) and the PFAS is transferred from the impacted phase to the fluorous phase of the F-media (8) and is removed from the impacted phase, thereby treating the impacted phase. The impacted phase/treated phase is then separated from the F-media (8) and discharged via line (410). The treated phase can be recirculated back to the primary contact reactor via recirculation line (411) and/or conveyed to further processing via discharge line (412). As the F-media adsorbs PFAS and reaches its adsorption capacity, a regeneration sequence would begin similar to as described in Section 1 and in FIG. 2 and FIG. 3 to recover PFAS.

In some embodiments, the regeneration solution may comprise a fluorinated solvent. For example, a PFAS-contaminated solid matrix may enter the CSTR along with a fluorinated solvent/reagent(s) and be maintained for an appropriate residence that allows for at least partial removal of PFAS from the solid matrix. Following adequate time, the mixture enters a separation stage, which may be a sedimentation tank or a centrifuge. After adequate time for complete separation, the concentrated fluorinated solvent is then drawn from the tank and recirculated back to the CSTR for reuse and a portion of it is sent to a downstream recovery or destruction treatment process. If the process is operated as a batch process, the solvent is completely drained from the separation stage and water may be added to wash the solid prior to discharge. If the process is operated as a continuous process, the solvent may be continuously drained/recirculated, and water may be added as the solid/solvent mixture enters the separation stage. The solid/solvent/aqueous may form distinct phases after adequate separation time and can be removed continuously from the system. A membrane layer may be added at an appropriate location in the settling stage to ensure that the solids are maintained in the appropriate aqueous layer. The size and position of the membrane layer will depend on the F-solvent, aqueous layer, and treated matrix density distribution and particle size.

FIG. 10a shows a version of PFAS recovery reactions using a regeneration solution (11) with carbon dioxide (11c), a cationic polyelectrolyte (425), a nonionic polyelectrolyte (426), and cationic (427) and nonionic (428) fluorinated solvents, and acidic agent (429) that is introduced into the contact reactor (400) to desorb PFAS from a solid phase with a liquid/solid extraction. The cationic polyelectrolyte (425) will tend to form stable pairs (431) with the anionic forms of PFAS (250) such that the PFAS is desorbed from the solid/liquid interface (445). The cationic F-solvent (427) will tend to form stable pairs (432) with the anionic forms of PFAS (250) such that the PFAS is desorbed from the solid/liquid interface (433). Similarly, the nonionic F-solvent (428) will tend to form stable pairs (434) with nonionic forms of PFAS (252) such that the PFAS is desorbed from the solid/liquid interface (435). The nonionic polyelectrolyte (426) will tend to form stable pairs (437) with the nonionic PFAS (252) such that the PFAS is desorbed from the solid/liquid interface (438).

Similar to FIG. 6a, the carbon dioxide dissociates into water to form carbonate species and stable pairs with PFAS, including PFAS-carbon dioxide (441), PFAS-carbonic acid (442), PFAS-bicarbonate (443), and PFAS-carbonate (444) facilitating the partitioning of PFAS to the solid/liquid interface. In some embodiments, the scheme for transitioning the regeneration solution (11) to an anti-solvent can follow that discussed for FIG. 6b, the adsorption of PFAS to F-media can follow that discussed for FIG. 6c, and the desorption of PFAS from the F-media can follow that discussed for FIG. 6d.

### Section 5. Multiphasic System Embodiment for PFAS-Impacted Aqueous and/or Solid Phase with Mixed Media Packed Bed Reactor

In these embodiments, the contact reactor (e.g., packed bed reactor) may comprise F-media and/or media such as to enhance the partitioning of the compound to a particular phase and/or serve as a reactant and/or catalyst for a reaction. In some embodiments, a packed bed reactor may comprise a pretreatment process. In some embodiments, the packed bed reactor may comprise a fluorous system.

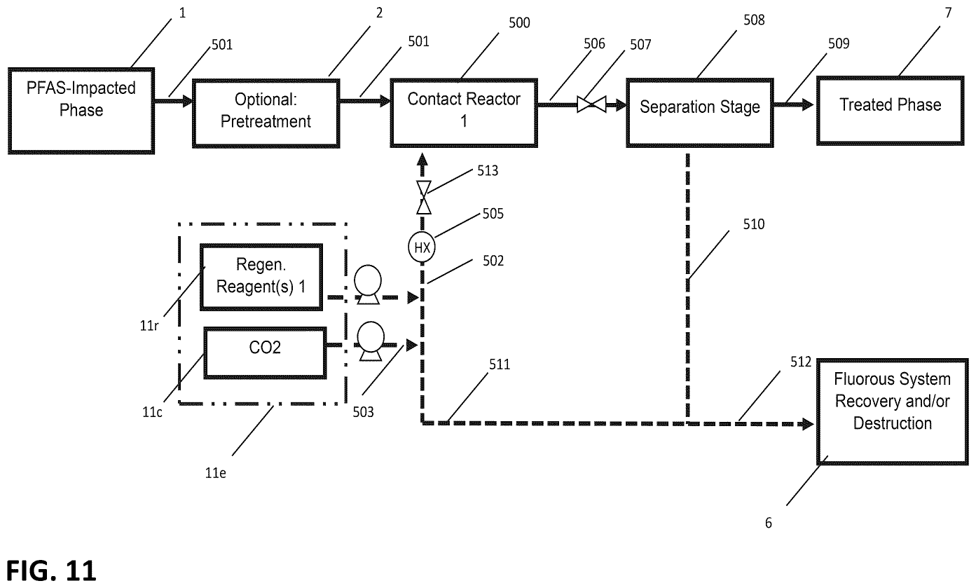

As shown in the embodiment of FIG. 11, a PFAS-impacted phase (1) is fed to a contact reactor (500) through feed line (501). In some embodiments, the PFAS-impacted phase (1) may be pretreated prior to being fed to contact reactor (500). In some embodiments, the contact reactor (500) is a packed bed reactor. In other embodiments, the contact reactor (500) is a pressure vessel. A regeneration solution (11) may be delivered into the contact reactor (500) through injection line (502). In some embodiments, the regeneration solution comprises a fluorous solvent. In some embodiments, the regeneration solution may also comprise an organic solvent. Carbon dioxide may be added to the contract reactor (500) through carbon dioxide injection line (503) coupled to the contact reactor (500) or injection line (502). The system may include a pump or compressor (504) to pressurize contact reactor (500) and the system may include a heating element (505) to heat the fluid.

The PFAS-impacted phase (1) and regeneration solution phase (11e) are mixed in the contact reactor for an appropriate residence time in the contact reactor (500) that results in at least partial partitioning of the PFAS compounds to the regeneration solution and/or fluorinated media phase. After a given residence time, the mixture is discharged from an outlet of the contact reactor (500) via discharge line (506), the mixture is depressurized through a back-pressure regulator (507), and then conveyed to a coupled separator (508) downstream. The separator (508) has an outlet for each of the phases, wherein the phase with PFAS removed (i.e., the treated phase (7)) is separated via a discharge line (509) and the regeneration solution phase (510) is recirculated back to the contact reactor via recirculation line (511) or conveyed to further processing via discharge line (512).

Similar to as described in Section 1 and in FIG. 2 and FIG. 3, as the PFAS-impacted phase (1) passes over the F-media (8) and/or regeneration solution phase (11) in the contact reactor (500), the PFAS is transferred from the impacted phase to the regeneration solution phase (11) and is removed from the impacted phase, thereby treating the impacted phase.

For example, in some embodiments, a PFAS-impacted aqueous matrix is filtered and pumped to a packed bed reactor with a fluorinated solvent/reagent(s). The packed bed reactor may contain a solid phase fluorinated reagent (such as Teflon pellets or others), a solid species that can influence the electrostatic interactions with the compounds such as Zero Valent Metals (such as ZVI or others), or others. As the liquid flows through the bed, the PFAS-contaminated matrix is treated as PFAS molecules attach to the solid reagent and mobilize to the fluorinated solvent phase. Filter screens on the packed bed reactor, maintain the solid reagent in suspension and prevent it from transferring downstream. After adequate contact time in the reactor, the aqueous phase and PFAS concentrated fluorinated phase mixture enter a separation stage, which may be a settling tank or a centrifuge. After adequate time for complete separation, the treated aqueous phase may decanted/drawn from the top of the tank and discharged for further processing and/or discharge. The point of exit of the aqueous phase may not immediately be at the top of the tank as PFAS compounds tend to partition to air/water interfaces, so the pipe may be located beneath the surface of the phase, but well above the fluorinated solvent layer. The concentrated fluorinated solvent may then be recirculated back to the packed bed reactor for reuse and a portion of it is sent to a recovery process and/or downstream destruction treatment process. If a fluorinated solid is used within the reactor, a fluorous solvent may or may not be included with the fluorinated solid in the reactor.

### Section 6. Multiphasic System Embodiment for PFAS-Impacted Aqueous Phase with Foam Fractionation, LLE, and Fluorous System

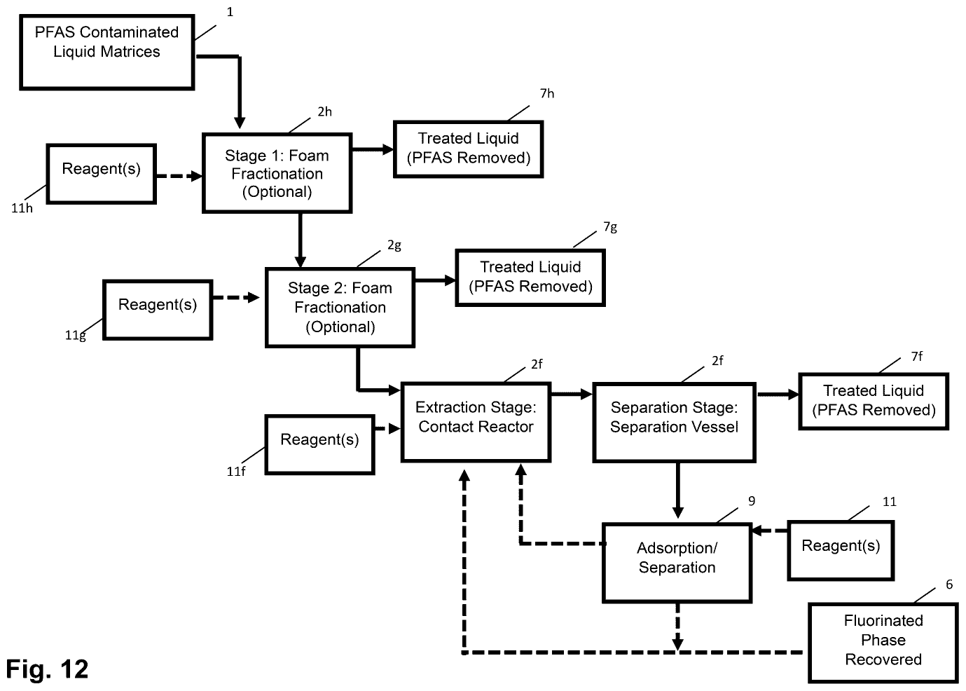

FIG. 12 provides a block diagram illustration (an example method embodiment) for a selective extraction process for recovering PFAS from an industrial wastewater in the presence of inorganics.

In this embodiment the wastewater (1) is conveyed to a foam fractionation system (2h) where air is sparged into a contact reactor to enhance the partitioning of PFAS from the wastewater to the concentrated residual. In some embodiments, the carbon dioxide may delivered into the contact reactor by being included in the air delivered into the reactor. The concentration in the air is elevated to enhance PFAS transfer to the concentrated residual. In some embodiments, the carbon dioxide concentration >0.02 wt %, >0.04 wt %, >0.8 wt %, >1.6 wt %, >2.5 wt %, >5 wt %, or >10 wt %.

In some embodiments, a fluorinated surfactant (11h) may be dosed into the foam fractionation contact reactor to enhance the transfer of PFAS from the wastewater to the concentrated residual. In some embodiments, a cationic fluorinated surfactant (11h) may be dosed into the foam fractionation contact reactor to enhance the transfer of PFAS from the wastewater to the concentrated residual (e.g., CTAB). The treated wastewater (7h) is then removed from the lower portion of the foam fractionation contact reactor and the PFAS concentrated residual is removed from the upper portion of the foam fractionation contact reactor for further treatment and/or discharge. In some embodiments, the inorganic compounds (e.g., sulfate, chloride, etc.) may be concentrated in the PFAS concentrated foam fractionation residual.

Depending on the properties of the PFAS concentrated foam fractionation residual, the PFAS concentrated foam fractionation residual may be conveyed to a secondary stage of a foam fractionation contact reactor (2g). In some embodiments, the secondary stage of foam fractionation contact reactor may comprise reagent(s) (11g) similar to that from the primary stage (e.g., elevated carbon dioxide concentration, organic surfactant(s), and/or a fluorinated surfactant(s)). In this stage, the pH may be adjusted and/or reagents (11g) including one or more of a fluorous solvent and a fluorous surfactant may be dosed into the contact reactor (2g). In some embodiments, the pH may be reduced to a range of about <6 to about <4 during this stage. In some embodiments, the reagents (11g) may include a neutral fluorous surfactant. In other embodiments, the fluorous solvent may be acidic. In some embodiments, CO₂ may be vented from the upper portion of the contact reactor (2g) of this secondary stage. The treated wastewater (7g) may be removed from the lower portion of the foam fractionation contact reactor and the PFAS concentrated residual is removed from the upper portion of the foam fractionation contact reactor for further treatment and/or discharge. In some embodiments, the inorganic compounds (e.g., sulfate, chloride, etc.) may be concentrated in the PFAS concentrated foam fractionation residual.

The PFAS concentrated residual from the secondary stage is then conveyed to contact reactor for liquid-liquid extraction (LLE) with a fluorinated solvent (2f). In some embodiments, regeneration reagent(s) (11f) are added during LLE. In some embodiments, the reagents may include a fluorinated solvent, and optionally an organic solvent to modify the partitioning behavior of the mixture. In some embodiments, supercritical carbon dioxide may be added to modify the partitioning behavior. In embodiments where CO₂ is included as a reagent, appropriate pressure/temperature adjustments applied in the contact reactor (2f) to provide conditions for supercritical CO₂.

Each of the phases added to the contact reactor are in contact for an sufficient amount of time for the PFAS to transfer from the PFAS concentrated foam fractionation residual to the fluorinated solvent phase. The mixture is then conveyed from the contact reactor to a separation stage. After adequate time in the separation stage, the phases separate based on density. In some embodiments, where only the wastewater residual and fluorinated solvent are present, there will be two phases that separate. In some embodiments, where the wastewater residual, fluorinated solvent, and organic solvent are present, there will be three phases that separate. The CO₂ in the mixture may be vented or recycled and reused.

In some embodiments, an ion-selective separation stage may supplement or replace the LLE stage depending on inorganic concentrations in the PFAS concentrated residuals. For example, an ion-selective nanofiltration membrane may be considered to separate sulfates, chlorides, and/or other constituents from various PFAS compounds to reduce the transfer of inorganics to downstream treatment processes.

The aqueous wastewater residual may comprise inorganics (7f) and can be conveyed for further treatment. The PFAS concentrated residual is then conveyed to a packed bed reactor (9) containing a fluorinated media to adsorb the PFAS. In some embodiments, no inorganics are used in this stage. The fluorinated phase may contain an organic solvent phase to modify the partitioning behavior. As the PFAS concentrated residual contacts the fluorinated media in the packed bed reactor, the PFAS transfers from the PFAS concentrated residual to the fluorinated media in the packed bed. The residual effluent from the packed bed reactor is then recycled back to the process at a plurality of locations to recover solvent. Once the fluorinated media in the packed bed reactor have reached their adsorption capacity and become exhausted, a regeneration cycle is initiated to desorb the PFAS from the fluorinated media with regeneration reagent(s) (11). The regeneration solution may comprise a fluorinated solvent as disclosed herein. In some embodiments, the regeneration cycle comprises the addition of supercritical CO₂ to enhance partitioning. The regeneration solution may be circulated in the reactor for a sufficient time to transfer the PFAS from the F-media in the packed bed to the fluorinated solvent. Subsequently, the fluorinated solvent may be recovered or further treated in recovery process (6).

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A method for transferring PFAS from a PFAS-impacted phase, comprising:
a. introducing an extraction medium comprising at least one polyelectrolyte and carbon dioxide into a vessel containing PFAS-impacted media with PFAS adsorbed thereon;
b. applying pressure and heat within the vessel to generate supercritical carbon dioxide; and
c. maintaining contact between the extraction medium and the PFAS-impacted media under supercritical carbon dioxide conditions for a sufficient time to transfer PFAS from the PFAS-impacted media to the extraction medium.

2. The method of claim 1, further comprising separating the PFAS-laden extraction medium from the PFAS-impacted media.

3. (canceled)

4. (canceled)

5. (canceled)

6. (canceled)

7. (canceled)

8. The method of claim 1, wherein the temperature within the vessel is maintained at less than 200° C. and the pressure within the vessel is maintained at greater than 1.000 psi.

9. (canceled)

10. The method of claim 1, further comprising:
a. separating the PFAS-laden extraction medium into a PFAS-concentrated phase and a treated extraction medium phase; and
b. recirculating the treated extraction medium phase back into the vessel for reuse.

11. (canceled)

12. The method of claim 1, further comprising converting the PFAS-laden extraction medium into an anti-solvent phase, wherein converting comprises:
a. adding water and a pH adjustment reagent;
b. Cooling the extraction medium; and
c. Depressurizing the extraction medium.

13. The method of claim 11, further comprising:
a. recovering PFAS from the anti-solvent by contacting the anti-solvent with a solid phase, wherein the solid phase comprises activated carbon, ion-exchange resin, cyclodextrin, a fluorous functionally modified media, or veracious combinations thereof; and
b. separating the anti-solvent from the PFAS-concentrated solid phase.

14. (canceled)

15. (canceled)

16. (canceled)

17. (canceled)

18. A method for removing, concentrating, and recovering PFAS from a PFAS-impacted phase comprises:
a. Introducing a PFAS-impacted phase into a vessel containing a fluorous material;
b. Adsorbing PFAS from the PFAS-impacted phase to said fluorous material to remove at least a portion of said PFAS from the PFAS-impacted phase to yield a treated phase;
c. Separating the treated phase from said fluorous material containing said PFAS;
d. Recovering PFAS from said fluorous material in said contact reactor, wherein recovering PFAS comprises:
i. introducing a solvent phase comprising a polyelectrolyte and carbon dioxide into said contact reactor with said fluorous material;
ii. pressurizing and heating the solvent phase and fluorous material, thereby generating supercritical carbon dioxide in said contact reactor;
iii. transferring at least a portion of said PFAS from said fluorous material to said solvent phase in said contact reactor; and
iv. Separating the PFAS-laden solvent phase from said fluorous material in said contact reactor.

19. (canceled)

20. The method of claim 18, further comprising converting said PFAS-laden solvent phase to an anti-solvent phase, wherein converting the solvent phase to an anti-solvent phase comprises adding water and a pH adjustment reagent, cooling, and depressurizing the PFAS-laden solvent phase.

21. (canceled)

22. (canceled)

23. (canceled)

24. (canceled)

25. (canceled)

26. (canceled)

27. (canceled)

28. (canceled)

29. (canceled)

30. The method of claim 18, wherein the solvent phase further comprises a fluorous solvent.

31. (canceled)

32. The method of claim 18, wherein a temperature of the solvent phase is <200 deg C. in said vessel and a pressure of the solvent phase is >1.000 psi in said vessel.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. The method of claim 20, wherein converting the solvent phase to an anti-solvent phase comprises decreasing the pressure to <1,000 psi and adding an alkaline agent comprises increasing the pH>6.

46. (canceled)

47. (canceled)

48. The method of claim 18, wherein the PFAS-impacted phase is pretreated prior to being introduced to a contact reactor, wherein pretreating a PFAS-impacted phase comprises liquid/liquid extraction or solid/liquid extraction comprising:
a. introducing a PFAS-impacted phase to a contact reactor;
b. introducing a pre-treatment solvent phase to said contact reactor, wherein the solvent phase comprises an organic solvent and an F-solvent;
c. transferring PFAS from a PFAS-impacted phase to said pre-treatment solvent phase in said contact reactor, wherein at least a portion of the PFAS is transferred from the PFAS-impacted phase to the pre-treatment solvent phase; and
d. separating the PFAS-impacted phase from the pre-treatment solvent phase.

49. The method of claim 18, wherein the PFAS-impacted phase is pretreated prior to being introduced to a contact reactor, wherein pretreating a PFAS-impacted phase comprises foam fractionation comprising:
a. Introducing a PFAS-impacted phase to the contact reactor;
b. Introducing a gas into the contact reactor;
c. producing a froth that rises to the upper portion of the contact reactor;
d. capturing at least a portion of PFAS from the PFAS-impacted phase in the froth; and
e. separating the froth from the PFAS-impacted phase.

50. The method of claim 18, wherein the PFAS-impacted phase is pretreated prior to being introduced to a contact reactor, wherein pretreating a PFAS-impacted phase comprises adsorption comprising:
a. introducing a PFAS-impacted phase to a contact reactor;
b. introducing an adsorption media to a contact reactor;
c. adsorbing PFAS from a PFAS-impacted phase to said adsorption media in said contact reactor;
d. recovering PFAS from said adsorption media in said contact reactor, wherein recovering PFAS comprises:
i. introducing a pre-treatment solvent phase comprising supercritical carbon dioxide, polyelectrolyte, water, and a pH adjustment reagent into said contact reactor;
ii. pressurizing and heating the pre-treatment solvent phase and adsorption media;
iii. transferring PFAS from said adsorption media to said pre-treatment solvent phase in said contact reactor;
iv. separating the pre-treatment solvent phase from said adsorption media in said contact reactor;
v. recirculating at least part of said pre-treatment solvent back into said contact reactor;
vi. adding water and a pH adjustment reagent, cooling, and depressurizing at least part of said pre-treatment solvent phase.

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. A method for pretreating, concentrating, and recovering PFAS from a PFAS-impacted phase, comprising:
a. introducing the PFAS-impacted phase into a pretreatment reactor;
b. performing a pretreatment process to partially separate PFAS from the PFAS-impacted phase;
c. a solid-liquid extraction, including contacting the PFAS-impacted phase with a fluorinated solid phase to adsorb PFAS; and
d. a regeneration step to remove the PFAS from said fluorinated solid phase, including contacting the fluorinated solid phase with a regeneration solvent phase comprising a polyelectrolytes and supercritical CO₂.

76. (canceled)

77. (canceled)

78. The method of claim 75, further comprising:
a. introducing a solvent phase to the PFAS-concentrated froth or PFAS-impacted phase in the pretreatment reactor;
b. elevating the pressure and temperature of the solvent phase to achieve supercritical carbon dioxide conditions;
c. transferring PFAS from the PFAS-impacted phase to the solvent phase; and
d. separating the PFAS-laden solvent phase from the treated PFAS-impacted phase.

79. The method of claim 75, wherein the pretreatment process comprises foam fractionation, further comprising:
a. introducing a gas into the PFAS-impacted phase to produce froth enriched in PFAS;
b. separating the froth from the treated PFAS-impacted phase; and
c. subjecting the froth to further treatment to extract concentrated PFAS.

80. The method of claim 75, wherein the pretreatment process comprises liquid/liquid extraction, further comprising:
a. contacting the PFAS-impacted phase with a fluorinated solvent;
b. mixing the PFAS-impacted phase and solvent phase to transfer PFAS from the PFAS-impacted phase to the solvent phase; and
c. separating the PFAS-concentrated solvent phase from the treated PFAS-impacted phase.

81. (canceled)

82. (canceled)

83. The method of claim 75, further comprising concentrating PFAS from the PFAS-laden solvent phase, wherein concentrating comprises:
a. converting the solvent phase to an anti-solvent phase by performing at least one of adjusting pH, cooling, and depressurizing the solvent phase;
b. separating PFAS from the anti-solvent phase; and
c. recovering the concentrated PFAS for further treatment or reuse.

84. The method of claim 75, wherein the PFAS-impacted phase comprises a solid matrix, the method further comprises:
a. introducing a solvent phase to the solid matrix to extract PFAS;
b. applying pressure and temperature to enhance the extraction process; and
c. separating the PFAS-concentrated solvent phase from the solid matrix.

85-99. (canceled)
